(19) United States
(12) Patent Application Publication
(10) Pub. No.: US 2021/0303979 A1
(43) Pub. Date: Sep. 30, 2021

(54) NEURAL NETWORK DEVICE, NEURAL NETWORK SYSTEM, AND OPERATION METHOD EXECUTED BY NEURAL NETWORK DEVICE

(71) Applicants: Kabushiki Kaisha Toshiba, Tokyo (JP); Toshiba Electronic Devices & Storage Corporation, Tokyo (JP)

(72) Inventor: Masanori Nishizawa, Tokyo (JP)

(21) Appl. No.: 17/018,292

(22) Filed: Sep. 11, 2020

(30) Foreign Application Priority Data
Mar. 24, 2020 (JP) 2020-052341

(51) Int. Cl. G06N 3/063; G06N 3/08

(52) U.S. Cl. CPC G06N 3/063; G06N 3/08

(57) ABSTRACT

According to an embodiment, a neural network device includes a circuit configured to receive a first bit sequence representing a first value and output a second bit sequence representing a threefold value of the first value. The device includes a circuit configured to generate a fourth bit sequence based on the first and second bit sequences and two adjacent bits of a third bit sequence representing a second value, and output a fifth bit sequence representing a product of the first and second values based on the fourth bit sequence, and to generate a seventh bit sequence based on the first and second bit sequences and two adjacent bits of a sixth bit sequence representing a third value, and output an eighth bit sequence representing a product of the first and third values based on the seventh bit sequence.

### CROSS-REFERENCE TO RELATED APPLICATIONS

This application is based upon and claims the benefit of priority from Japanese Patent Application No. 2020-052341, filed Mar. 24, 2020, the entire contents of which are incorporated herein by reference.

### FIELD

Embodiments generally relate to a neural network device, a neural network system, and an operation method executed by the neural network device.

### BACKGROUND

Recently, artificial intelligence (AI) has been actively developed. As one such AI technology, a neural network is known. Research on a method for implementing AI in hardware has also been actively conducted.

### BRIEF DESCRIPTION OF THE DRAWINGS

FIG. 1 is a block diagram showing an example of the configuration of a neural network system including an identification circuit according to a first embodiment.

FIG. 2 is a conceptual diagram of an example of the neural network implemented by the identification circuit according to the first embodiment.

FIG. 3 shows an example of data generation processing executed by each node of a layer of the neural network implemented by the identification circuit according to the first embodiment.

FIG. 4 is a block diagram showing an example of the configuration of the identification circuit according to the first embodiment.

FIG. 5 is an example of the configuration of a pre-calculation circuit of the identification circuit according to the first embodiment.

FIG. 6 is a diagram for explaining a method used for a multiplication of a value represented by a plurality of bits and another value represented by a plurality of bits.

FIG. 7 is a block diagram showing an example of the configuration of a multiplier circuit of the identification circuit according to the first embodiment.

FIG. 8 is an example of the circuit configuration of a partial product operation circuit in the multiplier circuit of the identification circuit according to the first embodiment.

FIG. 9 shows an example of the circuit configurations of a select signal generation circuit and a multiplexer circuit of the identification circuit according to the first embodiment.

FIG. 10 shows a truth table showing combinations of two bit values received by the select signal generation circuit of the identification circuit according to the first embodiment, three bit values output from the select signal generation circuit in accordance with each combination, and a bit value output from a multiplexer circuit in accordance with each combination.

FIG. 11 is a block diagram showing an example of the configuration of a partial product adder circuit in the multiplier circuit of the identification circuit according to the first embodiment.

FIG. 12 shows an example of the configuration of a carry-save adder.

FIG. 13 shows an example of the circuit configuration of a unit carry-save adder.

FIG. 14 shows an example of the circuit configuration of an exclusive OR circuit.

FIG. 15 shows a truth table showing combinations of three bit values received by a unit carry-save adder and a combination of two bit values output from the adder in accordance with each combination.

FIG. 16 is a flowchart showing an example of the operation executed by the identification circuit according to the first embodiment.

FIG. 17 is a block diagram showing an example of the configuration of an identification circuit according to a comparative example.

FIG. 18 is a block diagram showing an example of the configuration of a multiplier circuit of the identification circuit according to the comparative example.

FIG. 19 is an example of the circuit configuration of a partial product operation circuit in the multiplier circuit of the identification circuit according to the comparative example.

FIG. 20 is a block diagram showing an example of the configuration of a partial product adder circuit in the multiplier circuit of the identification circuit according to the comparative example.

FIG. 21 is an exemplary table showing the roughly estimated number of gates included in each of the multiplier circuit of the identification circuit according to the comparative example and the multiplier circuit of the identification circuit according to the first embodiment.

FIG. 22 is an example of the circuit configuration of a partial product operation circuit in a multiplier circuit of an identification circuit according to a second embodiment.

FIG. 23 shows an example of the circuit configurations of a multiplexer circuit of the identification circuit according to the second embodiment.

FIG. 24 shows an example of the circuit configuration of a multiplexer.

FIG. 25 is an exemplary table showing the roughly estimated number of gates included in the multiplier circuit of the identification circuit according to the second embodiment.

### DETAILED DESCRIPTION

In general, according to an embodiment, a neural network device includes a first circuit configured to receive a first bit sequence representing a first value and output a second bit sequence representing a threefold value of the first value. The neural network device includes a second circuit configured to receive the first bit sequence and the second bit sequence, to receive a third bit sequence representing a second value, generate a fourth bit sequence based on the first bit sequence, the second bit sequence, and first and second bits of adjacent digits of the third bit sequence, and output a fifth bit sequence representing a product of the first value and the second value based on the fourth bit sequence, and to receive a sixth bit sequence representing a third value, generate a seventh bit sequence based on the first bit sequence, the second bit sequence, and third and fourth bits of adjacent digits of the sixth bit sequence, and output an eighth bit sequence representing a product of the first value and the third value based on the seventh bit sequence.

Hereinafter, embodiments will be described with reference to the accompanying drawings. In the following description, constituent elements having the same function and configuration will be assigned a common reference symbol. When multiple constituent elements with a common reference symbol need to be distinguished from one another, additional symbols or numerals are added after the common reference symbol for distinction. When multiple constituent elements need not be particularly distinguished from each other, the constituent elements are assigned only a common reference symbol without additional symbols or numerals. The embodiments to be described below are mere exemplifications of a device and method for embodying a technical idea, and the shape, configuration, arrangement, etc. of each component are not limited to the ones described below.

Each function block can be implemented in the form of hardware, software, or a combination thereof. The function blocks need not necessarily be separated as in the following examples. For example, a function may be partly executed by a function block different from the function block described as an example. In addition, the function block described as an example may be divided into smaller function sub-blocks. The same applies to the circuit blocks. The names of the function blocks and circuit blocks in the following description are assigned for convenience, and do not limit the configurations or operations of the function blocks and circuit blocks

### <First Embodiment>

An identification circuit (hereinafter also referred to as a neural network device) 1 according to a first embodiment will be described below.

[Configuration Example]

(1) System

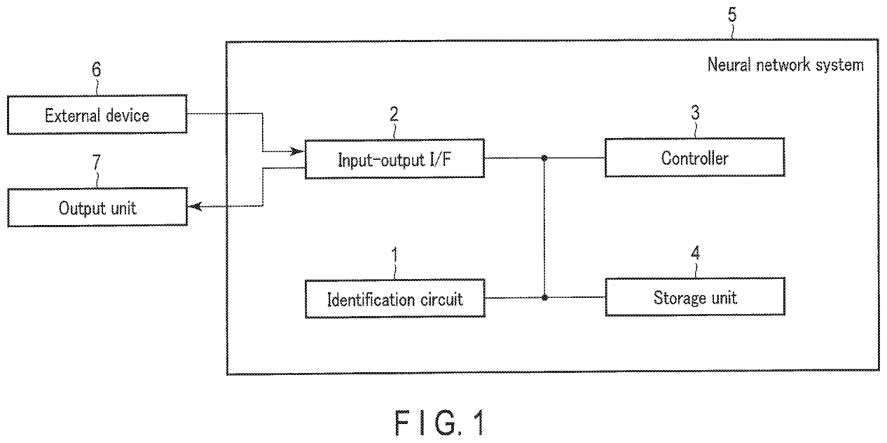

FIG. 1 is a block diagram showing an example of the configuration of a neural network system 5 including the identification circuit 1 according to the first embodiment. The identification circuit 1 is, for example, a graphics processing unit (GPU), and processes input data, such as image data, and executes processing for identifying an image or the like indicated by the input data (hereinafter referred to as “identification processing”). In the identification processing, for example a feature extraction by a neural network is utilized.

The neural network system 5 includes the identification circuit 1, an input-output interface (I/F) 2, a controller 3, and a storage unit 4.

The input-output interface 2 receives input data from an external device 6, such as a data server or an imaging device, and transmits the input data to the identification circuit 1. The input-output interface 2 also receives output data from the identification circuit 1, and transfers the output data to an output unit 7, such as a display.

The controller 3 controls the entire operation of the neural network system 5. The controller 3 may be integrated with the identification circuit 1.

The storage unit 4 includes, for example, a random access memory (RAM) and/or a read only memory (ROM). The ROM stores firmware (a program). The RAM can retain the firmware and is used as a work area of the controller 3. The RAM also temporarily retains data, and functions as a buffer and a cache. The firmware stored in the ROM and loaded into the RAM is executed by the controller 3. Each function of the neural network system 5 is thereby implemented.

The storage unit 4 stores, for example, weight coefficients (hereinafter also simply referred to as “weights”) and biases.

The identification circuit 1 receives input data transmitted from the input-output interface 2, and executes identification processing or learning processing.

When performing identification processing, the identification circuit 1 reads, for example, the weight coefficients and biases stored in the storage unit 4. Thereafter, the identification circuit 1 executes identification processing of the input data by means of a neural network that uses the weight coefficients and biases. The identification circuit 1 transmits output data indicating the identification result to the input-output interface 2.

In learning processing, the identification circuit 1 calculates weight coefficients and biases using the input data as training data. The calculated weight coefficients and biases are stored in, for example, the storage unit 4. The learning processing need not necessarily be executed before the identification processing, and may be executed, for example, between one identification processing and another identification processing. Execution of learning processing based on more training data may enhance the accuracy of the identification result obtained by the identification processing.

(2) Neural Network of Identification Circuit

The neural network is a network that artificially simulates signal transmission performed between neurons in the human brain.

The human brain includes a large number of neurons, and processes various types of information through signal transmission between neurons. A neuron receives signals respectively from a plurality of neurons, and transmits a signal to another neuron when the received, signals satisfy a condition.

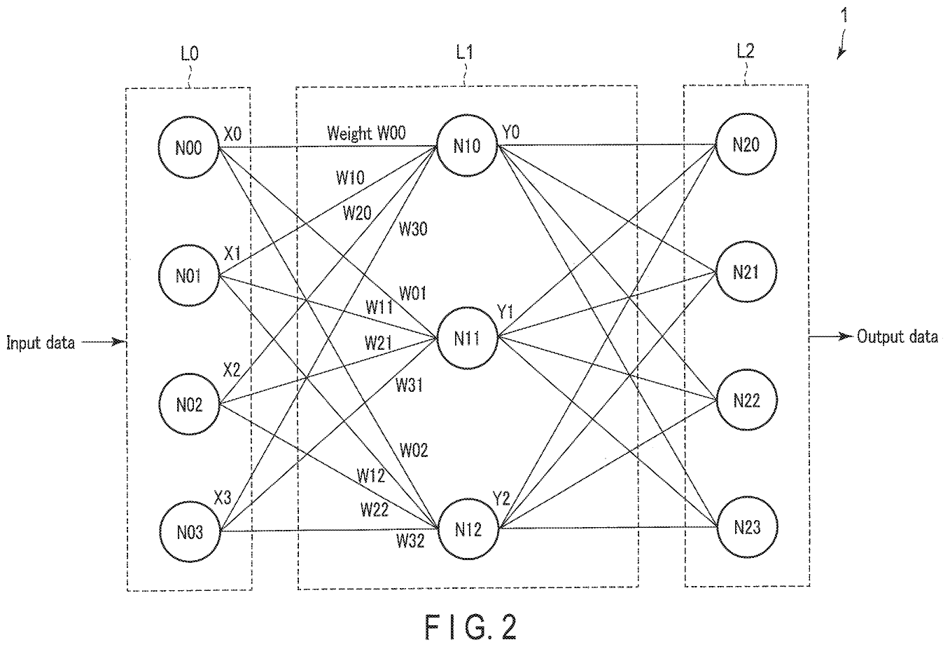

FIG. 2 is a conceptual diagram of an example of a neural network implemented by the identification circuit 1 according to the first embodiment.

Note that each of the data items in the following description is, for example, a bit sequence that represents a value in binary form using a plurality of bits. The value will be referred to as a value of the data item. The same applies to the bit sequences other than those referred to as data items in the following description. The bit of each digit is represented by 0 or 1.

The neural network is constituted by, for example, an input layer L0, an intermediate layer L1, and an output layer L2.

The input layer L0 is constituted by, for example, nodes N00, N01, N02, and N03. The intermediate layer L1 is constituted by, for example, nodes N10, N11, and N12. The output layer L2 is constituted by, for example, nodes N20, N21, N22, and N23. The number of nodes constituting each layer is not limited to the above, and each layer may be constituted by any number of nodes. Each node simulates a brain neuron.

The input layer L0 receives input data from the input-output interface 2. Each node of the input layer L0 transmits a data item based on the input data to, for example, each node of the intermediate layer L1. Specifically, the node N00, node N01, node N02, and node N03 respectively transmit a data item X0, data item X1, data item X2, and data item X3 to each node of the intermediate layer L1. Each data item X is generated by, for example, dividing input data.

Each node of the intermediate layer L1 receives the data items transmitted from the respective nodes of the input. layer L0, and generates another data item based on the received data items. Each node of the intermediate layer L1 transmits the generated data item to, for example, each node of the output layer L2. Details will be described below.

The node N10 receives the data items X0, X1, X2, and X3. The node N10 generates a data item Y0 based on the received. data items and weights associated with combinations of the node N10 and the respective nodes from which the data items are transmitted. Thereafter, the node N10 transmits the data item. Y0 to each node of the output layer L2. The combination of the node N00 and the node N10, the combination of the node N01 and the node N10, the combination of the node N02 and the node N10, and the combination of the node N03 and the node N10 are associated in one-to-one correspondence with weights W00, W10, W20, and W30, respectively. Each weight W is also a bit sequence that represents a value in binary form using a plurality of bits, for example.

Similarly, each of the nodes N11 and N12 receives the data items X0, X1, X2, and X3. The node N11 generates a data item Y1 based on the received data items and weights associated with combinations of the node N11 and the respective nodes from which the data items are transmitted. Thereafter, the node N11 transmits the data item Y1 to each node of the output layer L2. The node N12 generates a data item Y2 based on the received data items and weights associated with combinations of the node N12 and the respective nodes from which the data items are transmitted. Thereafter, the node N12 transmits the data item Y2 to each node of the output layer L2. The combination of the node N00 and the node N11, the combination of the node N01 and the node N11, the combination of the node N02 and the node N11, and the combination of the node N03 and the node N11 are associated in one-to-one correspondence with weights W01, W11, W21, and W31, respectively. The combination of the node N00 and the node N12, the combination of the node N01 and the node N12, the combination of the node N02 and the node N12, and the combination of the node N03 and the node N12 are associated in one-to-one correspondence with weights W02, W12, W22, and W32, respectively.

Each node of the output layer L2 receives the data items transmitted from the respective nodes of the intermediate layer L1, and generates an identification data item based on the received data items. Output data is generated based on, for example, the identification data item generated by each node. Details will be described below.

The node N receives the data items Y0, Y1, and Y2. The node N20 generates an identification data item based on the received data items and weights associated with combinations of the node N20 and the respective nodes from which the data items are transmitted.

Similarly, each of the nodes N21, N22, and N23 receives the data items Y0, Y1, and Y2. The node N21 generates an identification data item based on the received data items and weights associated with combinations of the node N21 and the respective nodes from which the data items are transmitted. The node N22 generates an identification data item based on the received data items and weights associated with combinations of the node N22 and the respective nodes from which the data items are transmitted. The node N23 generates an identification data item based on the received data items and weights associated with combinations of the node N23 and the respective nodes from which the data items are transmitted.

Output data based on, the identification data items generated by the respective nodes of the output layer L2 is transmitted to, for example, the input-output interface 2. The output data corresponds to, for example, the identification result of the input data.

Described above is the case where the identification circuit 1 includes only one intermediate layer; however, the configuration of the identification circuit 1 according to the present embodiment is not limited to this. The identification circuit 1 may include any number of intermediate layers. When the identification circuit 1 includes a plurality of intermediate layers, each node of the input layer L0 can transmit a data item to each node of the first intermediate layer, and each node of the first intermediate layer can transmit a data item to each node of the second intermediate layer. Similar transmissions are repeated to reach the last intermediate layer, and each node of the last intermediate layer can transmit a data item to each node of the output layer L2. The nodes of each layer each execute processing similar to the above-described ones.

Described above is the case where each node of a layer can receive a data item from each node of the preceding layer and can transmit a data item to each node of the subsequent layer; however, the configuration of the identification circuit 1 according to the present embodiment is not limited to such a configuration. The configuration of the identification circuit 1 according to the present embodiment may include a configuration in which some of the transmissions and receptions of data items are not performed. Such a configuration may be implemented by, for example, setting zero to the value of the weight associated with two nodes between which a data item is not transmitted or received in the above-described configuration.

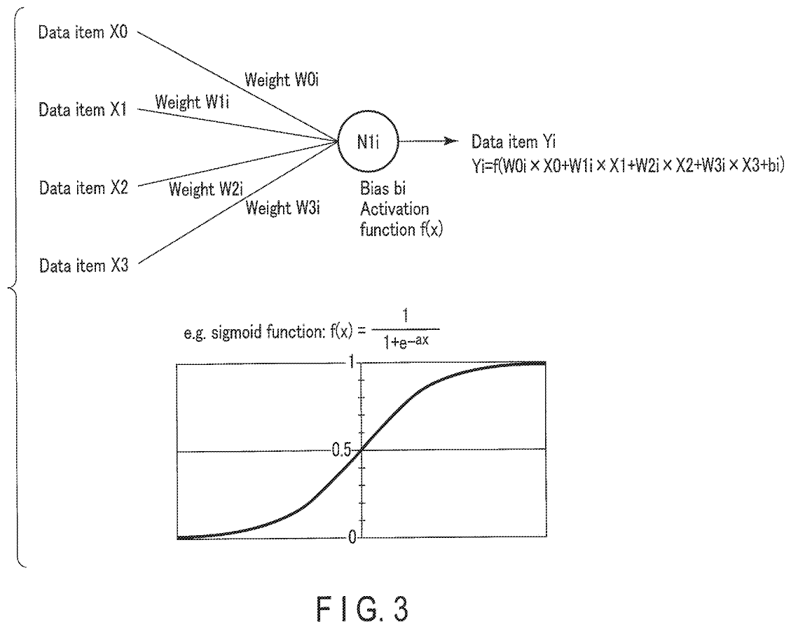

FIG. 3 shows an example of data generation processing executed by each node of the intermediate layer L1 of the neural network implemented by the identification circuit 1 according to the first embodiment. Data generation processing similar to the data generation processing to be described below may be executed by each node of the other layers such as the output layer L2. Hereinafter, i is an integer of 0 to 2. In the example of FIG. 2, the following description applies to each of the cases where i is integers from 0 to 2.

As described with reference to FIG. 2, the node N1i receives the data items X0, X1, X2, and X3 and generates the data item Yi, and transmits the generated data item Yi to each node of the output layer L2. The data items received by the node N1i are the same regardless of which integer i is.

Generation processing of the data item Yi the node N1i will be described below.

In the following, generating a data item of a bit sequence representing a product of the value of a data item α and the value of a data item β will be referred to as calculating a product α×β or multiplying a data item α by a data item β. The generated data item itself will be referred to as a product α×β or a data item α×β. Generating a data item of a bit sequence representing a sum of the value of a data item γ and the value of a data item δ will be referred to a calculating a sum (γ+δ) or summing a data item γ and a data item δ. The generated data item itself will be referred to as a sum (γ+δ) or a data item (γ+δ). Generating a data item of a bit sequence representing the value of f (ε) yielded by substituting the value of a data item ε for the variant x of a function f (x) will be referred to as calculating f (ε).

The node N1i first calculates a product W0i×X0, a product W1i×X1, a product W2i×X2, and a product W3i×X3, and calculates a sum (W0i×X0+W1i×X1+W2i×X2+W3i×X3+bi) based on the calculated data items and a bias bi. The bias bi is also a bit sequence that represents a value in binary form using a plurality of bits, for example. Next, the node N1i calculates f(W0i×X0+W1i×X1+W2i×X2+W3i×X3+bi) by substituting the calculated value of the sum for the variable x of the activation function f(x). The node N1i transmits the calculation result to each node of the output layer L2 as the data item Yi.

As the activation function, for example, a sigmoid function, f(x)=1/{1+exp(−ax)}, is used. The sigmoid function f(x) is a monotonically increasing function, and the value of f(x) is closer to 0 when the value of x is smaller, and is closer to 1 when the value of x is larger. The graph of y=f(x) of the sigmoid function f(x) plotted on the x−y plane is symmetrical with respect to (x, y)=(0, 0.5).

As shown in the graph, according to the sigmoid function f(x), when the value of x is smaller than 0, the value of f(x) is closer to 0, whereas when the value of x is larger than 0, the value of f(x) is closer to 1. In the case of FIG. 3, the value of the sum (W0i×X0+W1i×X1+W2i×X2+W3i×X3+bi) is substituted for x. Accordingly, when the value of the sum (W0i×X0+W1i×X1+W2i×X2+W3i×X3) is smaller than the value of −bi, the value of f(x) is closer to 0, and when the value of the sum (W0i×X0+W1i×X1+W2i×X2+W3i×X3) is larger than the value of −bi, the value of f(x) is closer to 1. In this way, −bi may be regarded as a threshold.

As described above, each node of the neural network simulates a brain neuron's reaction of transmitting a signal to another neuron when signals received from a plurality of neurons satisfy a condition (comparison with a threshold).

(3) Specific Configuration for Implementing Neural Network

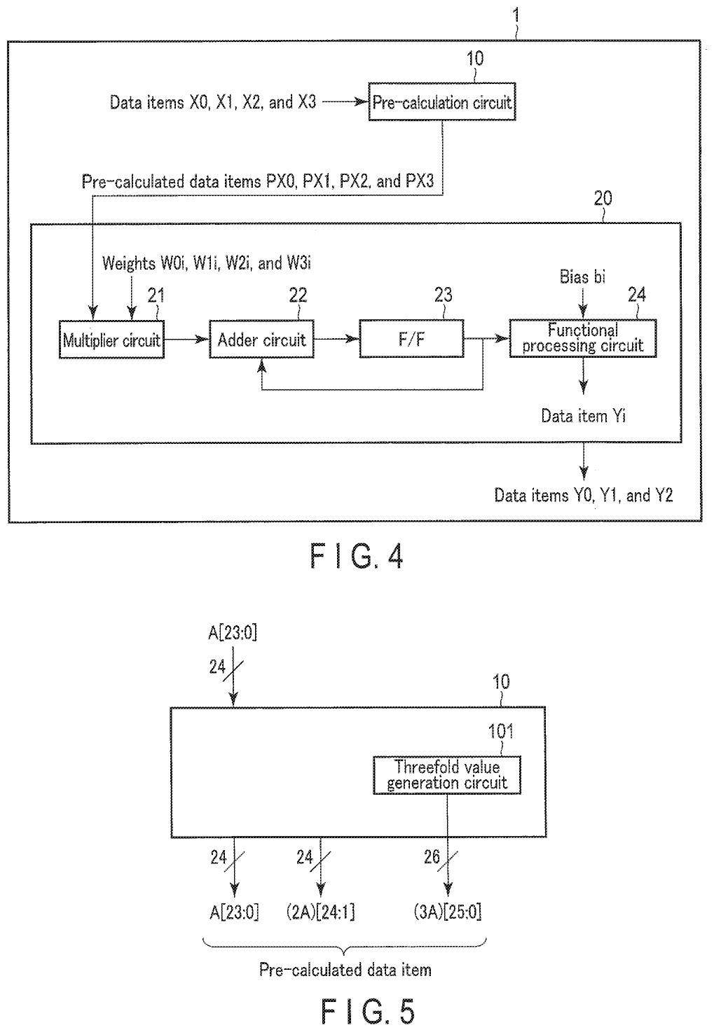

FIG. 4 is a block diagram showing an example of the configuration of the identification circuit 1 according to the first embodiment.

The identification circuit 1 includes, for example, a pre-calculation circuit 10 and a node processing circuit 20.

The pre-calculation circuit 10 receives the data item X0. The pre-calculation circuit 10 generates a pre-calculated data item PX0 based on the received data item X0. The pre-calculation circuit 10 transmits the generated data item PX0 to the node processing circuit 20, for example.

Hereinafter, the case where the pre-calculation circuit 10 transmits the data item PX0 to the node processing circuit 20 will be described; however, the present embodiment is not limited to this case. For example, the data item PX0 may be transmitted by the pre-calculation circuit 10 to the storage unit 4, stored in the storage unit 4, and acquired by the node processing circuit 20 from the storage unit 4. The same applies to the other data items described as being transmitted from the pre-calculation circuit 10 to the node processing circuit 20.

Similarly, the pre-calculation circuit 10 receives the data item X1, generates a pre-calculated data item PX1 based on the data item X1, and for example transmits the data item PX1 to the node processing circuit 20. The pre-calculation circuit 10 also receives the data item X2, generates a pre-calculated data item PX2 based on the data item X2, and for example transmits the data item PX2 to the node processing circuit 20. The pre-calculation circuit 10 also receives the data item X3, generates a pre-calculated data item PX3 based on the data item X3, and for example transmits the data item PX3 to the node processing circuit 20.

Some of the above-described processing relating to the data item X0, processing relating to the data item X1, processing relating to the data item X2, and processing relating to the data item X3 by the pre-calculation circuit 10 may be executed in a partly overlapping manner.

The node processing circuit 20 receives the data items PX0, PX1, PX2, and PX3. The node processing circuit 20 generates the data items Y0, Y1, and Y2 based on the four received data items. The node processing circuit 20 outputs the generated data items Y0, Y1, and Y2. Namely, the node processing circuit 20 executes processing corresponding to the data generation processing executed by each node, which is described with reference to FIG. 3.

The configuration of the node processing circuit 20 will be described below in more detail.

The node processing circuit 20 includes a multiplier circuit 21. The node processing circuit 20 also includes, for example, an adder circuit 22, a flip-flop circuit (F/F) 23, and a functional processing circuit 24.

The multiplier circuit 21 acquires the data item PX0 and the weight W0i. The multiplier circuit 21 calculates the product W0i×X0 based on the data item PX0 and the weight W0i. The multiplier circuit 21 transmits the calculated product W0i×X0 to the adder circuit 22.

Similarly, the multiplier circuit 21 acquires the data item PX1 and the weight W1i, calculates the product W1i×X1 based on the data item PX1 and the weight W1i, and transmits the product W1i×X1 to the adder circuit 22. The multiplier circuit 21 also acquires the data item PX2 and the weight W2i, calculates the product W2i×X2 based on the data item PX2 and the weight W2i, and transmits the product W2i×X2 to the adder circuit 22. Furthermore, the multiplier circuit 21 acquires the data item PX3 and the weight W3i, calculates the product W3i×X3 based on the data item PX3 and the weight W3i, and transmits the product W3i×X3 to the adder circuit 22.

Some of the above-described processing relating to the data item X0, processing relating to the data item X1, processing relating to the data item X2, and processing relating to the data item X3 by the multiplier circuit 21 may be executed in a partly overlapping manner.

The adder circuit 22 receives an output data item from the multiplier circuit 21 and an output data item from the flip-flop circuit 23, sums the two received data items, and transmits the data item sum to the flip-flop circuit 23. The flip-flop circuit 23 receives the data item sum, and transmits the data item sum to the adder circuit 22 and/or functional processing circuit 24 based on, for example, a clock signal.

Specifically, the adder circuit 22 and the flip-flop circuit 23 perform the following processing. For convenience, the following description will be provided on the assumption that the adder circuit 22 receives the product W0i×X0, the product W1i×X1, the product W2i×X2, and the product W3i×X3 from the multiplier circuit 21 in the order of their appearance.

First, the adder circuit 22 receives the product W0i×X0 from the multiplier circuit 21, and receives an initial output data item from the flip-flop circuit 23. The initial output data item is, for example, a bit sequence in which the bits of all digits are represented by 0. The adder circuit 22 sums the two received data items, and transmits the data item sum to the flip-flop circuit 23. The data item sum corresponds to the product W0i×X0. The flip-flop circuit 23 receives the data item sum, and outputs the data item sum to the adder circuit 22 based on, for example, a clock signal.

Thereafter, the adder circuit 22 receives the product W1i×X1 from the multiplier circuit 21, and receives the data item sum corresponding to the product W0i×X0 from the flip-flop circuit 23. The adder circuit 22 sums the two received data items, and transmits the data item sum to the flip-flop circuit 23. The data item sum corresponds to a sum (W0i×X0+W1i×X1). The flip-flop circuit 23 receives the data item sum, and outputs the data item sum to the adder circuit 22 based on, for example, a clock signal.

Thereafter, similar processing is further performed by the adder circuit 22 and the flip-flop circuit 23. As a result, the adder circuit 22 calculates the sum (W0i×X0+W1i×X1+W2i×X2+W3i×X3). The adder circuit 22 transmits the calculated sum to the flip-flop circuit 23, and the flip-flop circuit 23 transmits the sum to the functional processing circuit 24 based on, for example, a clock signal.

The functional processing circuit 24 receives the sum (W0i×X0+W1i×X1+W2i×X2+W3i×X3) from the flip-flop circuit 23, and acquires the bias bi. The functional processing circuit 24 substitutes the value of the sum (W0i×X0+W1i×X1+W2i×X2+W3i×X3+bi) obtained by summing the received sum and the bias bi for the variable x of the activation function f(x) to generate the data item Yi, and outputs the data item Yi. The data item Yi is output from the node processing circuit 20.

As noted above, i is an integer of 0 to 2. For all the cases where i is 0, 1, and 2, the multiplier circuit 21, the adder circuit 22, the flip-flop circuit 23, and the functional processing circuit 24 repeat the above-described processing. In this way, the node processing circuit 20 generates and outputs the data items Y0, Y1, and Y2.

Described above is how data generation processing by all the nodes of the intermediate layer L1 is implemented by the pre-calculation circuit 10 and the node processing circuit 20. Data generation processing by the nodes of another layer may be implemented by the pre-calculation circuit 10 and the node processing circuit 20. The pre-calculation circuit 10 and the node processing circuit 20 may be commonly used for data generation processing by the nodes of all the layers, or may be prepared for each layer and used for data generation processing by the nodes of one layer. The node processing circuit 20 may also be prepared for each node, and used for data generation processing by one node.

The configurations of the adder circuit 22, the flip-flop circuit 23, and the functional processing circuit 24 need not necessarily be limited to the above-described ones. Some of the circuits may not be included in the node processing circuit 20.

(4) Pre-Calculation Circuit

FIG. 5 is an example of the configuration of the pre-calculation circuit 10 of the identification circuit 1 according to the first embodiment.

In the following, a given data item of the data items X0, X1, X2, and X3 will be referred to as a data item A[23:0], as an example. The representation “data item A[23:0]” indicates that the data item A[23:0] is a bit sequence from the 0th digit to the 23rd digit. The value (0 or 1) represented as a bit will be referred to as a bit value. The same applies to similar representations below. Provided below is a description based on such data items; however, the configuration to be described below can be utilized for data items in various forms. For example, in a multiplication of two data items of the single-precision floating-point type, an addition and subtraction of the exponent parts of the two data items and a multiplication of the mantissa parts of the two data items are performed. The multiplication of the mantissa parts is implemented by the configuration to be described below.

Transmission and reception of a bit sequence such as a data item to be described below are performed as follows. For each bit included in a bit sequence, a bit value of the bit is transmitted and received via an interconnect associated with the digit of the bit. In the transmission and reception of the bit value, whether the bit value being transmitted. received is 0 or 1 is determined based on whether the voltage of the interconnect is at the high level or at the low level, for example.

The pre-calculation circuit 10 receives the data item A[23:0], and outputs the data item A[23:0] and a data item (2A)[24:1]. The data item (2A)[24:1] is a bit sequence that represents a twofold value of the value of the data item A[23:0], in which the bit value of each digit of the data item A[23:0] has been carried up by one digit. Accordingly, the series of bit values included in the data item (2A)[24:1] is the same as the series of bit values included in the data item A[23:0]. Therefore, a particular operational circuit need not be provided in the pre-calculation circuit 10 to output the data item (2A)[24:1].

For convenience, the following description will be provided on the assumption that the data item (2A)[24:1] is exchanged between circuits, and processing based on the data item (2A)[24:1] is performed in a circuit. In the processing, however, the data item A[23:0] can be used instead of the data item (2A)[24:1]. This is because the series of bit values included in the data item (2A)[24:1] is the same as the series of bit values included in the data item A[23:0]. Therefore, the exchange of the data item (2A)[24:1] to be described below need not necessarily be performed, and the processing based on the data item (2A)[24:1] need not necessarily be performed based on the data item (2A)[241] as long as it is also based on the data item A[23:0].

The pre-calculation circuit 10 includes a threefold value generation circuit 101. The threefold value generation circuit 101 generates a data item (3A)[25:0] based on the data item A[23:0], and outputs the generated data item (3A)[25:0]. The data item (3A)[25:0] is a bit sequence that represents a threefold value of the value of the data item A[23:0]. The threefold value generation circuit 101 generates the data item (3A)[25:0] by calculating a sum (A[23:0]+(2A)[24:1]), for example. The output data item (3A)[25:0] is also output from the pre-calculation circuit 10.

The set of the data item A[23:0], data item (2A)[24:1], and data item (3A)[25:0] output from the pre-calculation circuit 10 corresponds to the pre-calculated data item described with reference to FIG. 4.

(5) Multiplier Circuit

(5-1) Multiplication Method Used by Multiplier Circuit

First, a multiplication method used by the multiplier circuit 21 is described.

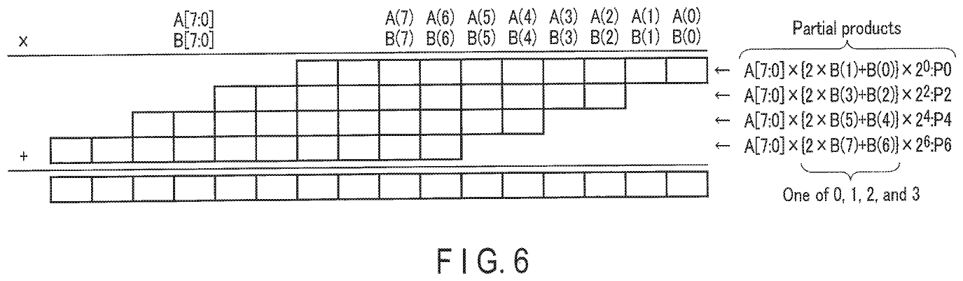

FIG. 6 is a diagram for explaining a method used for a multiplication of a value (multiplicand) represented by a plurality of bits and another value (multiplier) represented by a plurality of bits.

In FIG. 6, a multiplication in the case where the value of an 8-bit data item A[7:0] is a multiplicand and the value of an 8-bit data item B[7:0] is a multiplier is shown as an example. Let us assume that each of bit values A(0), A(1), . . . , and A(7) is a bit value of the digit represented by the numeral in the parentheses of the data item A. For example, A(5) is a bit value 0 or 1 of the fifth digit of the data item A. The same applies to B(0), B(1), . . . , and B(7) and similar representations below.

As shown in FIG. 6, partial products P0, P2, P4, and P6 are first calculated.

The partial product P0 is a product A[7:0]×B[1:0]. A data item B[1:0] is a bit sequence constituted by the bits of the 0th and first digits of the data item B[7:0]. The same applies to similar representations below. The partial product P0 is a bit sequence that represents a value obtained by multiplying the value of the data item A[7:0] by {2×B (1)+B (0)} and further multiplying the resultant value by 2⁰. 2×B (1)+B(0) is one of 0, 1, 2, and 3.

The partial product P2 is a product A[7:0]×B[3:2]. The partial product P2 is a bit sequence that represents a value obtained by multiplying the value of the data item A[7:0] by {2×B (3)+B(2) } and further multiplying the resultant value by 2². 2×B(3)+B(2) is also one of 0, 1, 2, and 3.

Similarly, the partial product P4 is a bit sequence that represents a value obtained by multiplying the value of the data item A[7:0] by {2×B (5)+B (4)} and further multiplying the resultant value by 2⁴. 2×B (5)+B (4) is also one of 0, 1, 2, and 3. The partial product P6 is a bit sequence that represents a value obtained by multiplying the value of the data item A[7:0] by {2×B (7)+B(6)} and further multiplying the resultant value by 2⁶. 2×B(7)+B(6) is also one of 0, 1, 2, and 3.

Accordingly, the series of bit values included in each partial product P includes a series of bit values included in a bit sequence that represents one of the zerofold value, onefold value, twofold value, and threefold value of the value of the data item A[7:0]. Which of the zerofold value, onefold value, twofold value, and threefold value the bit sequence represents is based on the bit values of the two bits used for calculating each partial product P of the data item B[7:0].

The product A[7:0]×B[7:0] is a sum (P0+P2+P4+P6).

(5-2) Configuration of Multiplier Circuit

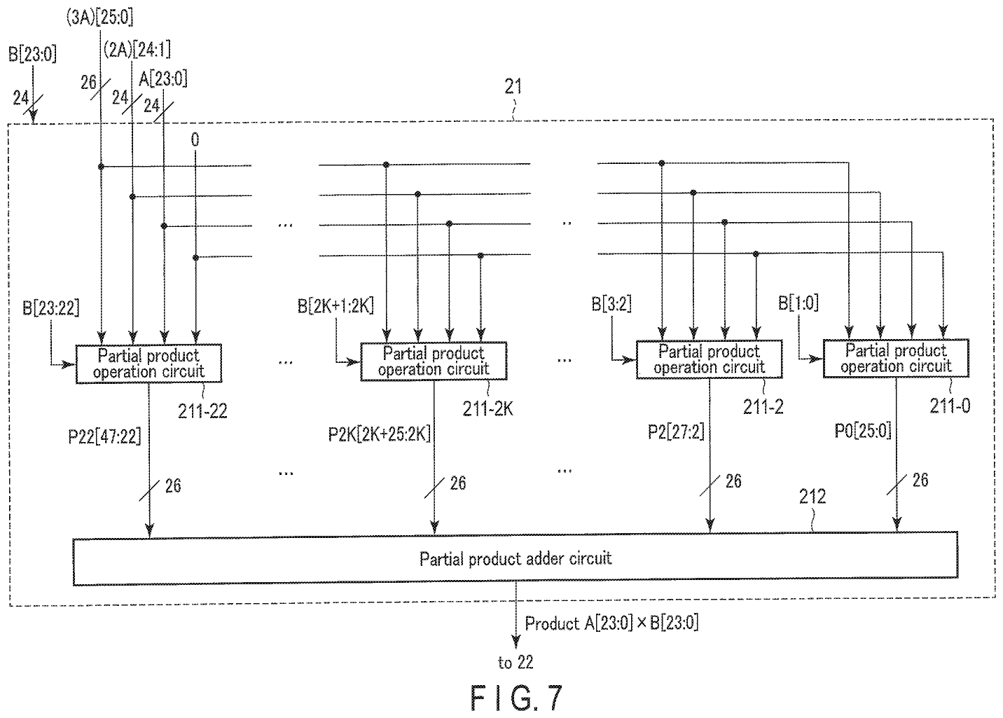

FIG. 7 is a block diagram showing an example of the configuration of the multiplier circuit 21 of the identification circuit 1 according to the first embodiment.

In the following, of the weights W0i, W1i, W2i, and W3i, the weight by which the data item A[23:0] is multiplied will be referred to as a data item B[23:0], as an example.

The multiplier circuit 21 includes partial product operation circuits 211-0, 211-2, 211-4, . . . , and 211-22, and a partial product adder circuit 212. FIG. 7 shows the partial product operation circuits 211-0, 211-2, and 211-22. Regarding the other partial product operation circuits, FIG. 7 representatively shows one partial product operation circuit 211-2K, where K is one of 2, 3, 4, 5, 6, 7, 8, 9, and 10.

The partial product operation circuits 211-0, 211-2, 211-4, . . . , and 211-22 each receive the data items A[23:0], (2A)[24:1], and (3A)[25:0] from the pre-calculation circuit 10, and bit value 0, for example. The bit value 0 is not always required, as in the case of the data item (2A)[24:1] described as not always being required with reference to FIG. 5. For example, bit value 0 generated in the partial product operation circuit can be substituted for the bit value 0.

The partial product operation circuit 211-0 receives a data item B[1:0] based on the data item B[23:0]. The partial product operation circuit 211-0 calculates a partial product data item P0[25:0], which is a product A[23:0]×B[1:0], based on the data items A[23:0], (2A)[24:1], and (3A)[25:0], bit value 0, and the data item B[1:0]. The partial product operation circuit 211-0 transmits the calculated partial product data item P0[25:0] to the partial product adder circuit 212. The partial product data item P0[25:0] corresponds to the partial product P0 of the example of FIG. 6.

The same applies to the other partial product operation circuits 211-2, 211-4, . . . , and 211. Hereinafter, k is an integer of 0 to 11. The following description using k applies to each of the cases where k is integers from 0 to 11, if nothing to the contrary is described.

The partial product operation circuit 211-2k receives a data item B [2k+1:2k] based on the data item B[23:0], and calculates a partial product data item P2k[2k+25:2k], which is a product A[23:0]×B[2k+1:2k], based on the data items A[23:0], (2A)[24:1], and (3A)[25:0], bit value 0, and the data item B[2k+1:2k]. The partial product operation circuit 211-2k transmits the calculated partial product data item P2k[2k+25:2k] to the partial product adder circuit 212. The partial product data item P2k[2k+25:2k] also corresponds to the partial product P2k of the example of FIG. 6.

The partial product adder circuit 212 receives the partial product data item P0[25:0] from the partial product operation circuit 211-0, receives the partial product data item P2[27:2] from the partial product operation circuit 211-2, . . . , and receives the partial product data item P22[47:22] from the partial product operation circuit 211-22. The partial product adder circuit 212 sums the received partial product data items to generate a product A[23:0]×B[23:0]. The partial product adder circuit 212 transmits the generated product A[23:0]×B[23:0] to the adder circuit 22.

(5-2-1) Configuration of Partial Product Operation Circuit

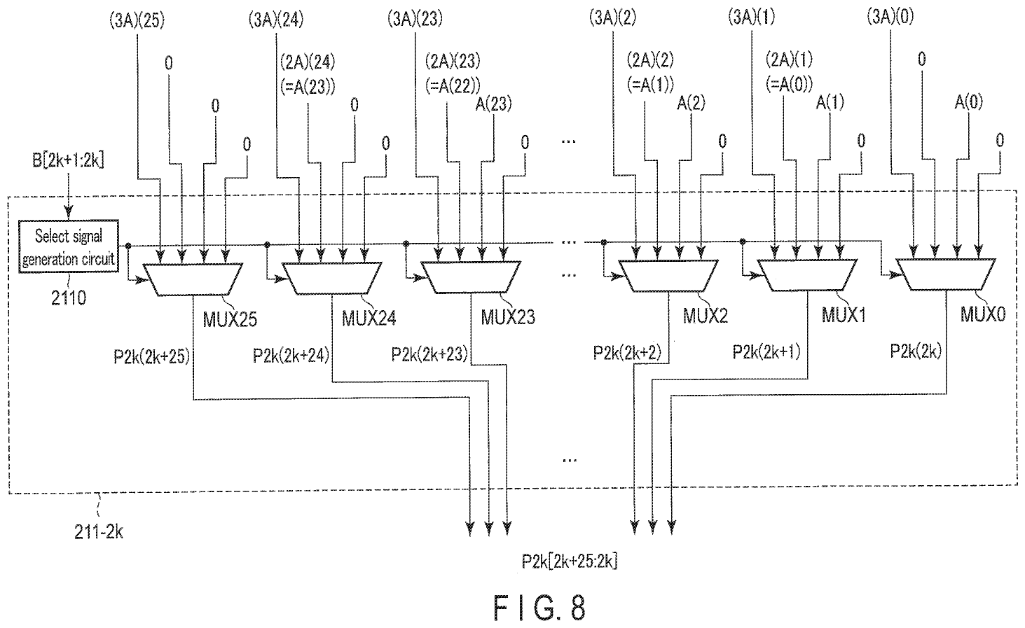

FIG. 8 is an example of the circuit configuration of the partial product operation circuit 211-2k in the multiplier circuit 21 of the identification circuit 1 according to the first embodiment.

The partial product operation circuit 211-2k includes a select signal generation circuit 2110 and multiplexer circuits MUX0, MUX1, MUX2, . . . , and MUX25. Each multiplexer circuit MUX includes, for example, a first input terminal, a second input terminal, a third input terminal, and a fourth input terminal.

The data items and bit value 0 described as being received by the partial product operation circuit 211-2k with reference to FIG. 7 are processed in the partial product operation circuit 211-2k as follows.

The multiplexer circuit MUX0 receives bit value 0 on the first input terminal, for example. The multiplexer circuit MUX0 receives the bit value A(0) on the second input terminal. The multiplexer circuit MUX0 receives bit value 0 on the third input terminal. This is because the data item (2A)[24:1] does not have the bit of the 0th digit. The multiplexer circuit MUX0 receives the bit value (3A) (0) on the fourth input terminal.

Hereinafter, j is an integer of 1 to 23. The following description applies to each of the cases where j is integers from 1 to 23.

The multiplexer circuit MUXj receives bit value 0 on the first input terminal. The multiplexer circuit MUXj receives the bit value A (j) on the second input terminal. The multiplexer circuit MUXj receives the bit value (2A) (j) on the third input terminal. The bit value (2A) (j) is the same as the bit value A (j-1). The multiplexer circuit MUXj receives the bit value (3A) (j) on the fourth input terminal.

The multiplexer circuit MUX24 receives the bit value 0 on the first input terminal. The multiplexer circuit MUX24 receives the bit value 0 on the second input terminal. This is because the data item A[23:0] does not have the bit of the 24th digit. The multiplexer circuit MUX24 receives the bit value (2A) (24) on the third input terminal. The bit value (2A) (24) is the same as the bit value A(23). The multiplexer circuit MUX24 receives the bit value (3A) (24) on the fourth input terminal.

The multiplexer circuit MUX25 receives bit value 0 on the first input terminal. The multiplexer circuit MUX25 receives bit value 0 on the second input terminal. This is because the data item A[23:0] does not have the bit of the 25th digit. The multiplexer circuit MUX25 receives bit value 0 on the third input terminal. This is because the data item (2A)[24:1] does not have the bit of the 25th digit. The multiplexer circuit MUX25 receives the bit value (3A) (25) on the fourth input terminal.

In this way, bit value 0 is transmitted to the first input terminals of the multiplexer circuits MUX0, MUX1, . . . , and MUX25. The bit values of the 24 digits of the data item A[23:0] are transmitted to the second input terminals of the multiplexer circuits MUX0, MUX1, . . . , and MUX23. The bit values of the 24 digits of the data item (2A)[24:1] are transmitted to the third input terminals of the multiplexer circuits MUX1, MUX2, . . . , and MUX24. The bit values of the 26 digits of the data item (3A)[25:0] are transmitted to the fourth input terminals of the multiplexer circuits MUX0, MUX1, . . . , and MUX25. As described above, bit value 0 is transmitted to the other second input terminals and third input terminals of the multiplexer circuits MUX.

The select signal generation circuit 2110 receives the data item B[2k+1:2k]. Based on the received data item B[2k+1:2k], the select signal generation circuit 2110 generates one of a select signal relating to bit value 0, a select signal relating to the data item A, a select signal relating to the data item 2A, and a select signal relating to the data item 3A.

Specifically, when each of the bit, values B(2k+1) and B(2k) is 0, i.e., when 2×B(2k+1)+B(2k) is 0, the select signal generation circuit 2110 generates a select signal relating to bit value 0. When the bit value B(2k+1) is 0 and the bit value B(2k) is 1, i.e., when 2×B(2k+1)+B(2k) is 1, the select signal generation circuit 2110 generates a select signal relating to the data item A. When the bit value B(2k+1) is 1 and the bit value B(2k) is 0, i.e., when 2×B(2k+1)+B(2k) is 2, the select signal generation circuit 2110 generates a select signal relating to the data item. 2A. When each of the bit values B (2k+1) and B(2k) is 1, i.e., when 2×B(2k+1)+B(2k) is 3, the select signal generation circuit 2110 generates a select signal relating to the data item 3A.

The select signal generation circuit 2110 transmits the generated select signal to each of the multiplexer circuits MUX0, MUX1, . . . , and MUX25.

Upon receipt of the select signal relating to bit value 0 from the select signal generation circuit 2110, each multiplexer circuit MUX for example outputs, on the output terminal, the bit value received on the first input terminal of the multiplexer circuit MUX.

Upon receipt of the select signal relating to the data item A from the select signal generation circuit 2110, each multiplexer circuit MUX outputs, on the output terminal, the bit value received on the second input terminal of the multiplexer circuit MUX.

Upon receipt of the select signal relating to the data item 2A from the select signal generation circuit 2110, each multiplexer circuit MUX outputs, on the output terminal, the bit value received on the third input terminal of the multiplexer circuit MUX.

Upon receipt of the select signal relating to the data item 3A from the select signal generation circuit 2110, each multiplexer circuit MUX outputs, on the output terminal, the bit value received on the fourth input terminal of the multiplexer circuit MUX.

In this way, the bit values output from the multiplexer circuits MUX0, MUX1, MUX2, . . . , MUX23, MUX24, and MUX25 in response to the select signal are output as bit values P2k(2k), P2k(2k+1), P2k(2k+2), . . . , P2k(2k+23), P2k(2k+24), and P2k(2k+25), respectively. A set of these bit values P2k(2k), P2k(2k+1), P2k(2k+2), . . . , P2k(2k+23), P2k(2k+24), and P2k(2k+25) is the partial product data item P2k[2k+25:2k] described with reference to FIG. 7.

It can be understood that, when the partial product data item P2k[2k+25:2k] is output, a bit sequence that represents a value obtained by multiplying the value of the data item A[23:0] by {2×B(2k+1)+B(2k)} and further multiplying the resultant value by 2^{2k} is output.

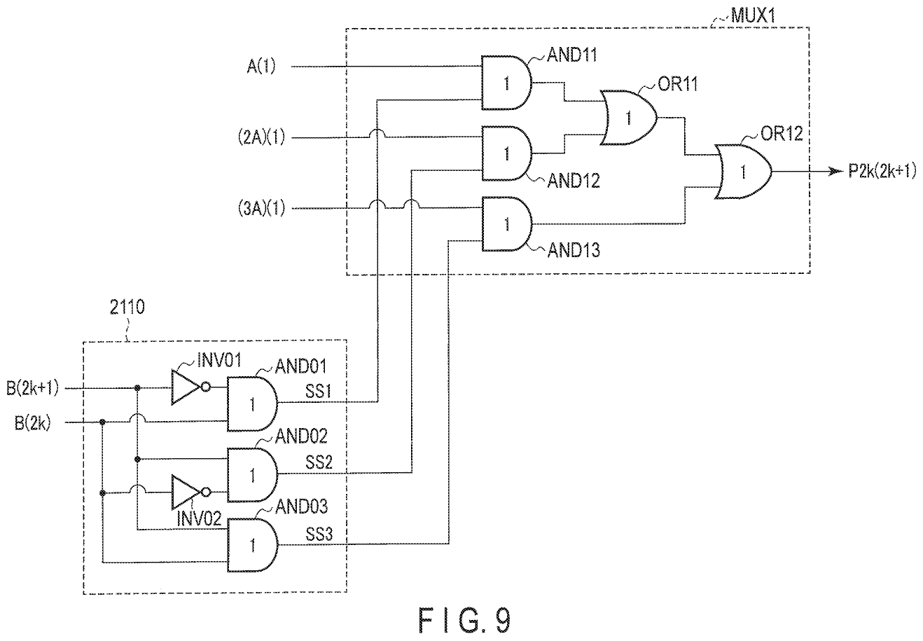

FIG. 9 shows an example of the circuit configurations of the select signal generation circuit 2110 and multiplexer circuit MUX1 of the identification circuit 1 according to the first embodiment. The other multiplexer circuits MUX may have the same circuit configuration. The numeral “1” in the symbols of the AND circuits and OR circuits shown in FIG. 9 will be used for explanation of advantageous effects. The same applies to the other drawings to be described below. The same applies to the other numerals in the symbols of the circuits other than the AND and OR circuits.

The select signal generation circuit 2110 includes, for example, inverters INV01 and INV02 and AND circuits AND01, AND02, and AND03.

Each bit value described as being received by the select signal generation circuit 2110 with reference to FIG. 8 is processed in the select signal generation circuit 2110 as follows.

The AND circuit AND01 receives, on the first input terminal, a value obtained by inverting the bit value B(2k+1) through the inverter INV01, and receives the bit value B(2k) on the second input terminal. Here, the inverted value of bit value 0 is bit value 1, and the inverted value of bit value 1 is bit value 0. The same applies to similar representations below. The AND circuit AND01 performs an AND operation on the two received bit values. The AND circuit AND01 outputs, on the output terminal, a bit value SS1, which is a result of the operation.

The AND circuit AND02 receives the bit value B(2k+1) on the first input terminal and receives, on the second input terminal, a value obtained by inverting the bit value B(2k) through the inverter INV02. The AND circuit AND02 performs an AND operation on the two received bit values. The AND circuit AND02 outputs, on the output terminal, a bit value SS2, which is a result of the operation.

The AND circuit AND03 receives the bit value B (2k+1) on the first input terminal, and receives the bit value B(2k) on the second input terminal. The AND circuit AND03 performs an AND operation on the two received bit values. The AND circuit AND03 outputs, on the output terminal, a bit value SS3, which is a result of the operation.

The combination of the bit values SS1, SS2, and SS3 is output as the above-described select signal from the select signal generation circuit 2110.

The multiplexer MUX1 includes, for example, AND circuits AND11, AND12, and AND13, and OR circuits OR11 and OR12.

Each bit value described as being received by the multiplexer circuit MUX1 with reference to FIG. 8 is processed in the multiplexer circuit MUX1 as follows.

The AND circuit AND11 receives the bit value A(1) on the first input terminal, and receives the bit value SS1 on the second input terminal.

The AND circuit ANDI2 receives the bit value (2A) (1) on the first input terminal, and receives the bit value SS2 on the second input terminal.

The AND circuit AND13 receives the bit value (3A) (1) on the first input terminal, and receives the bit value SS3 on the second input terminal.

Each of the AND circuits AND11, AND12, and AND13 performs an AND operation on the bit value received on the first input terminal and the bit value received on the second input terminal, and outputs, on the output terminal, a bit value which is a result of the operation.

The OR circuit OR11 receives, on the first input terminal, the bit value output from the AND circuit AND11 and receives, on the second input terminal, the bit value output from the AND circuit AND12. The OR circuit OR11 performs an OR operation on the two received bit values and outputs, on the output terminal, a bit value which is a result of the operation.

The OR circuit OR12 receives, on the first input terminal, the bit value output from the OR circuit OR11 and receives, on the second input terminal, the bit value output from the AND circuit AND13. The OR circuit OR12 performs an OR operation on the two received bit values and outputs, on the output terminal, the bit value P2k(2k+1), which is a result of the operation.

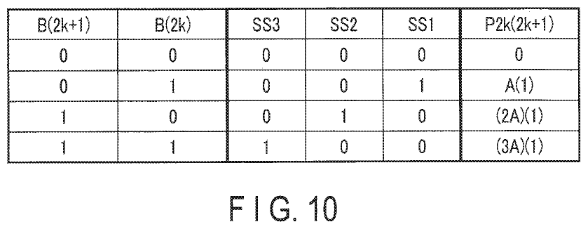

FIG. 10 shows a truth table showing combinations of bit values B(2k+1) and B(2k) received by the select signal generation circuit 2110, bit values SS1, SS2, and SS3 corresponding to each combination, and a bit value P2k(2k+1) output from the multiplexer circuit MUX1 in accordance with each combination. The following description is based on the circuit configurations shown in FIG. 9.

When each of the bit values B(2k+1) and B(2k) is 0, i.e., when. 2×B(2k+1)+B(2k) is 0, each of the bit values SS1, SS2, and SS3 is 0. The combination of the bit values SS1, SS2, and SS3 in this case is the select signal relating to bit value 0 described with reference to FIG. 8. In this case, bit value 0 is output from each of the AND circuits AND11, AND12, and AND13. Consequently, the bit value P2k(2k+1) is 0.

When the bit value B(2k+1) is 0 and the bit value B(2k) is 1, i.e., when 2×B(2k+1)+B(2k) is 1, the bit value SS1 is 1, and the bit values SS2 and SS3 are 0. The combination of the bit values SS1, SS2, and SS3 in this case is the select signal relating to the data item A described with reference to FIG. 8 in this case, the bit value A(1) is output from the AND circuit AND11, and bit value 0 is output from each of the AND circuits AND12 and AND13. Consequently, the bit value P2k(2k+1) is the same as the bit value A(1).

When the bit value B(2k+1) is 1 and the bit value B(2k) is 0, i.e., when 2×B(2k+1)+B(2k) is 2, the bit value SS2 is 1, and the bit values SS1 and SS3 are 0. The combination of the bit values SS1, SS2, and SS3 in this case is the select signal relating to the data item 2A described with reference to FIG. 8. In this case, the bit value (2A) (1) is output from the AND circuit AND12, and bit value 0 is output from each of the AND circuits AND11 and AND13. Consequently, the bit value P2k(2k+1) is the same as the bit value (2A) (1).

When each of the bit values B (2k+1) and B(2k) is 1, i.e., when 2×B(2k+1)+B(2k) is 3, the bit value SS3 is 1 and the bit values S1I and SS2 are 0. The combination of the bit values SS1, SS2, and SS3 in this case is the select signal relating to the data item 3A described with reference to FIG. 8. In this case, the bit value (3A) (1) is output from the AND circuit AND13, and bit value 0 is output from each of the AND circuits AND11 and AND12. Consequently, the bit value P2k(2k+1) is the same as the bit value (3A) (1).

Each of the other multiplexer circuits MUX is also configured to perform the operation for each combination of bit values B(2k) and B(2k+1).

By configuring each multiplexer circuit MUX as described above, the output from each multiplexer circuit MUX in response to the select signal as described with reference to FIG. 8 may be implemented.

(5-2-2) Configuration of Partial Product Adder Circuit

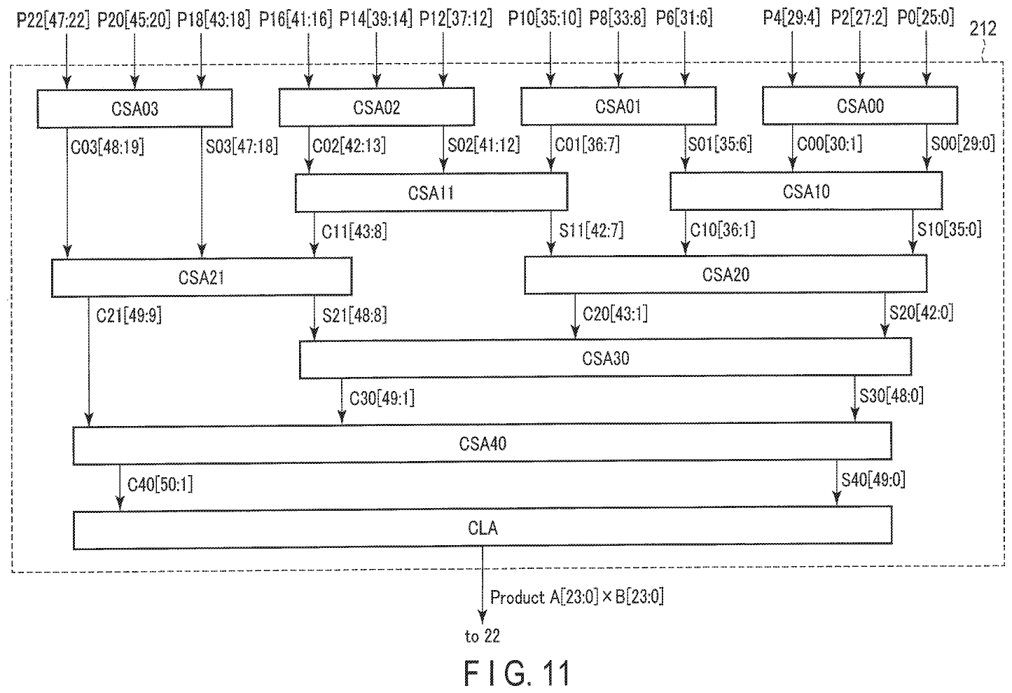

FIG. 11 is a block diagram showing an example of the configuration of the partial product adder circuit 212 in the multiplier circuit 21 of the identification circuit 1 according to the first embodiment.

The partial product adder circuit 212 has, for example, a Wallace tree structure in which a plurality of carry-save adders CSA are coupled in stages in a ramifying manner, and a carry lookahead adder CLA is coupled in the last stage.

The carry-save adders CSA are now described.

Each adder CSA receives three data items. Each adder CSA executes addition processing for the three received data items. In the addition processing, the bit values of the three received data items are summed for each digit. In the addition for a digit, a bit value of the digit after the addition and a bit value carried up from the digit by the addition are generated. The adder CSA outputs a series of bit values of all the digits after the addition as a data item S, and outputs a series of the carried-up bit values for all the digits as a data item C.

First, the carry-save adders CSA00, CSA01, CSA02, and CSA03 in the first stage are described.

The adder CSA00 receives data items P0[25:0], P2[27:2], and P4[29:4]. The adder CSA00 executes addition processing for the three received data items to generate a data item S00[29:0] and a data item C00[30:1], and outputs the two generated data items.

The adder CSA01 receives data items P6[31:6], P8[33:8], and P10[35:10]. The adder CSA01 executes addition processing for the three received data items to generate a data item S01[35:6] and a data item C01[36:7], and outputs the two generated data items.

The adder CSA02 receives data items P12[37:12], P14[39:14], and P16[41:16]. The adder CSA02 executes addition processing for the three received data items to generate a data item S02[41:12] and a data item C02[42:13], and outputs the two generated data items.

The adder CSA03 receives data items P18[43:18], P20[45:20], and P22[47:22]. The adder CSA03 executes addition processing for the three received data items to generate a data item S03[47:18] and a data item C03[48:19], and outputs the two generated data items.

Next, the carry-save adders CSA10 and CSA11 in the second stage are described.

The adder CSA10 receives the data item S00[29:0] and the data item C00[30:1] from the adder CSA00, and the data item S01[35:6] from the adder CSA01. The adder CSA10 executes addition processing for the three received data items to generate a data item S10[35:0] and a data item C10[36:1], and outputs the two generated data items.

The adder CSA11 receives the data item C01[36:7] from the adder CSA01, and the data item S02[41:12] and the data item C02[42:13] from the adder CSA02. The adder CSA11 executes addition processing for the three received data items to generate a data item S11[42:7] and a data item C11[43:8], and outputs the two generated items.

Next, the carry-save adders CSA20 and CSA21 in the third stage are described.

The adder CSA20 receives the data item S10[35:0] and the data item C10[36:1] from the adder CSA10, and the data item S11[42:7] from the adder CSA11. The adder CSA20 executes addition processing for the three received data items to generate a data item S20[42:0] and a data item C20[43:1], and outputs the two generated data items.

The adder CSA21 receives the data item C11[43:8] from the adder CSA11, and the data item S03[47:18] and the data item C03[48:19] from the adder CSA03. The adder CSA21 executes addition processing for the three received data items to generate a data item S21[48:8] and a data item C21[49:9], and outputs the two generated data items.

Finally, the carry-save adders CSA30 in the fourth stage and the carry-save adder CSA40 in the fifth stage are described.

The adder CSA30 receives the data item S20[42:0] and the data item C20[43:1] from the adder CSA20, and the data item S21[48:8] from the adder CSA21. The adder CSA30 executes addition processing for the three received data items to generate a data item S30[48:0] and a data item C30[49:1], and outputs the two generated data items.

The adder CSA40 receives the data item S30[48:0] and the data item C30[49:1] from the adder CSA30, and the data item C21[49:9] from the adder CSA21. The adder CSA40 executes addition processing for the three received data items to generate a data item S40[49:0] and a data item C40[50:1], and outputs the two generated data items.

The carry lookahead adder CLA receives the data item S40[49:0] and the data item C40[50:1] from the adder CSA40. The adder CLA sums the two received data items to generate a product A[23:0]×B[23:0], and outputs the generated product A[23:0]×B[23:0]. As described with reference to FIG. 7, the product A[23:0]×B[23:0] is transmitted to the adder circuit 22.

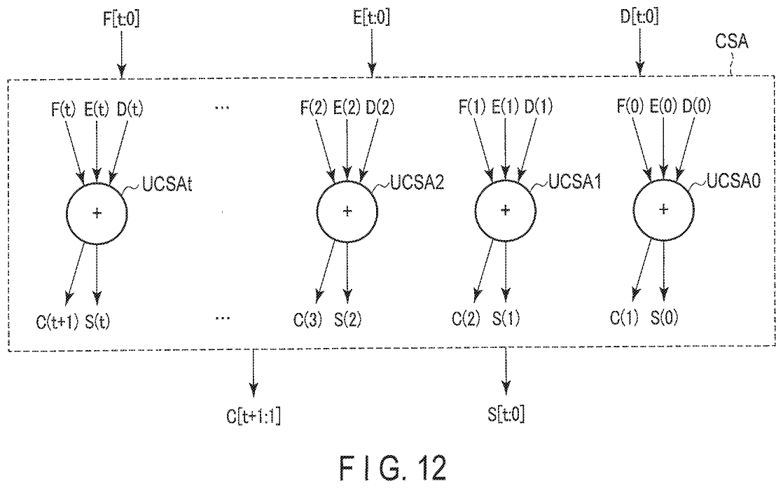

FIG. 12 shows an example of the configuration of a carry-save adder CSA. The adder CSA receives a data item D[t:0] a data item E[t:0], and a data item F[t:0] and executes addition processing for the three received data items t is an integer greater than or equal to 0.

The adder CSA includes unit carry-save adders UCSA0, UCSA1, UCSA2, . . . , and UCSAt prepared for respective 0th to t-th digits. Each adder UCSA includes a first input terminal, a second input terminal, and a third input terminal.

Each data item described as being received by the adder CSA is processed in the adder CSA as follows. Hereinafter, u is an integer of 0 to t. The following description applies to each of the cases where u is integers from 0 to t.

The adder UCSAu receives a bit value D(u) on the first input terminal, receives a bit value E(u) on the second input terminal, and receives a bit value F(u) on the third input terminal. The adder UCSAu sums the three received bit values. In the addition processing, a bit value S(u) of the u-th digit after the addition and a bit value C(u+1) carried up from the u-th digit by the addition are generated. The adder UCSAu outputs the bit value S(u) and the bit value C(u+1).

A set of the bit value S(0) from the adder UCSA0, the bit value S (1) from the adder UCSA1, . . . , and the bit value S(t) from the adder UCSAt is output as a data item S[t:0] from the adder CSA. A set of the bit value C(1) from the adder UCSA0, the bit value C(2) from the adder UCSA1, . . . , and the bit value C(t+1) from the adder UCSAt is output as a data item C[t+1:1] from the adder CSA.

Each carry-save adder CSA shown in FIG. 11 may have the same configuration as that described with reference to FIG. 12. For example, when the three data items received by the carry-save adder CSA are not bit sequences all constituted by a plurality of bits of digits in the same range, an adder UCSA is prepared in the adder CSA for each of the digits from the minimum digit to the maximum digit of the three ranges. An adder UCSA prepared for a digit not included in all of the three ranges receives, for example, 0 as an input from a data item of a plurality of bits of digits in a range that does not include the digit.

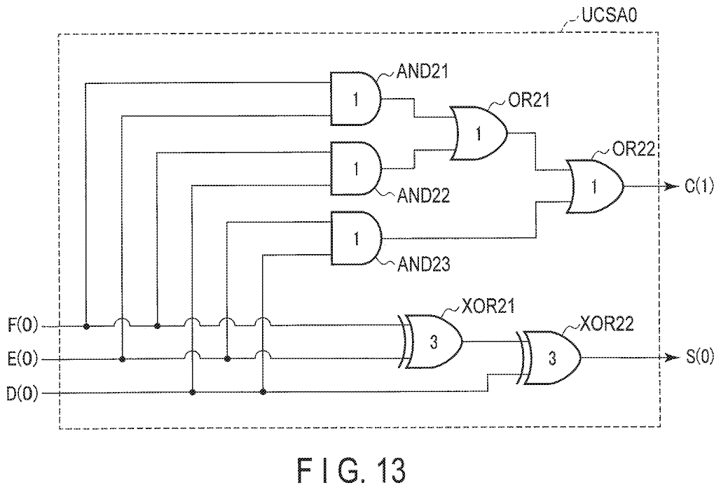

FIG. 13 shows an example of the circuit configuration of the adder UCSA0 shown in FIG. 12. Each of the other adders UCSA may have the same circuit configuration.

The adder UCSA0 includes, for example, AND circuits AND21, AND22, and AND23, OR circuits OR21 and OR22, and an exclusive OR circuits XOR21 and XOR22.

Each bit value described as being received by the adder UCSA0 with reference to FIG. 12 is processed in the adder UCSA0 as follows.

The AND circuit AND21 receives the bit value F(0) on the first input terminal and receives the bit value E(0) on the second input terminal.

The AND circuit AND 22 receives the bit value F(0) on the first input terminal and receives the bit value D(0) on the second input terminal.

The AND circuit AND23 receives the bit value E(0) on the first input terminal and receives the bit value D(0) on the second input terminal.

Each of the AND circuits AND21, AND22, and AND23 performs an AND operation on the bit value received on the first input terminal and the bit value received on the second input terminal, and outputs, on the output terminal, a bit value which is a result of the operation.

The OR circuit OR21 receives, on the first input terminal, the bit value output from the AND circuit AND21 and receives, on the second input terminal, the bit value output from the AND circuit AND22. The OR circuit OR21 performs an OR operation on the two received bit values, and outputs, on the output terminal, a bit value which is a result of the operation.

The OR circuit OR22 receives, on the first input terminal, the bit value output from the OR circuit OR21 and receives, on the second input terminal, the bit value output from the AND circuit AND23. The OR circuit OR22 performs an OR operation on the two received bit values, and outputs, on the output terminal, the bit value C(1), which is a result of the operation.

The bit value C(1) is now described.

When one or less of the bit values D(0), E(0), and F(0) is 1, bit value 0 is output from each of the AND circuits AND21, AND22, and AND23. Consequently, the bit value C(1) is 0.

When two or more of the bit values D(0), E(0), and F(0) are 1, bit value 1 is output from at least one of the AND circuits AND21, AND22, and AND23. Consequently, the bit value C(1) is 1.

The exclusive OR circuit XOR21 receives the value F(0) on the first input terminal and receives the bit value E(0) on the second input terminal. The exclusive OR circuit XOR21 performs an exclusive OR operation on the two received bit values, and outputs, on the output terminal, a bit value which is a result of the operation.

The exclusive OR circuit XOR22 receives, on the first input terminal, the bit value output from the exclusive OR circuit XOR21, and receives the bit value D(0) on the second input terminal. The exclusive OR circuit XOR22 performs an exclusive OR operation on the two received bit values, and outputs, on the output terminal, the bit value S(0), which is a result of the operation.

In the exclusive OR operation, if attention is focused on a bit value (first bit value) transmitted to the circuit that performs the operation, the bit value which is a result of the operation is the same as the first bit value when the other bit value (second bit value) transmitted to the circuit is 0, and is an inverted value of the first bit value when the second bit value is 1.

Each of the other adders UCSA is configured to perform the same operation on three bit values transmitted to the adder UCSA.

By configuring each adder UCSA as described above, the addition processing by each adder UCSA described with reference to FIG. 12 may be implemented.

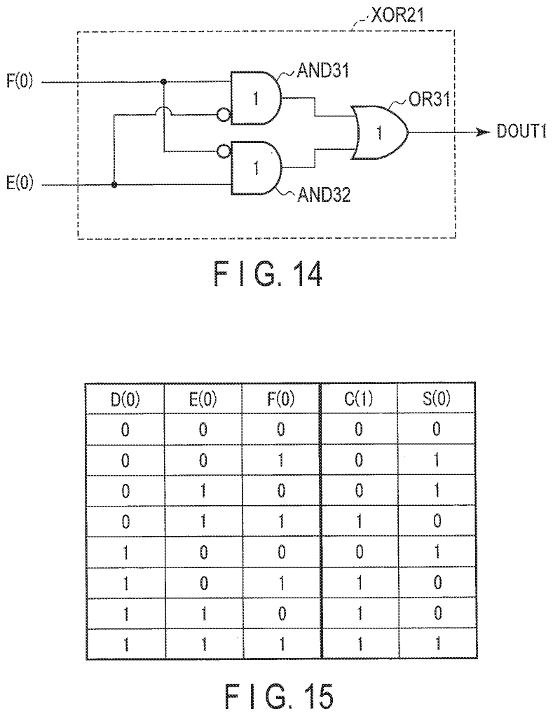

FIG. 14 shows an example of the circuit configuration of the exclusive OR circuit XOR21 shown in FIG. 13. The exclusive OR circuit XOR22 may also have the same circuit configuration.

The exclusive OR circuit XOR21 includes, for example, AND circuits AND31 and AND32 and an OR circuit OR31.

Each bit value described as being received by the exclusive OR circuit XOR21 with reference to FIG. 13 is processed in the exclusive OR circuit XOR21 as follows.

The AND circuit AND31 receives the bit value F(0) on the first input terminal and receives, on the second input terminal, a value obtained by inverting the bit value E(0), for example, through an inverter.

The AND circuit AND32 receives, on the first input terminal, a value obtained by inverting the bit value F(0), for example, through an inverter, and receives the bit value E(0) on the second input terminal.

Each of the AND circuits AND31 and AND32 performs an AND operation on the bit value received on the first input terminal and the bit value received on the second input terminal, and outputs, on the output terminal, a bit value which is a result of the operation.

The OR circuit OR31 receives, on the first input terminal, the bit value output from the AND circuit AND31 and receives, on the second input terminal, the bit value output from the AND circuit AND32. The OR circuit OR31 performs an OR operation on the two received bit values, and outputs, on the output terminal, a bit value which is a result of the operation. The bit value shown as DOUT1 in FIG. 14 is output from the exclusive OR circuit XOR21.

Hereinafter, the bit value of DOUT1 will be described.

The case where the bit value E(0) is 0 is now described. When the bit value F(0) is 0, bit value 0 is output from both of the AND circuits AND31 and AND32. Consequently, bit value 0 is output from the exclusive OR circuit XOR21. In contrast, when the bit value F (0) is 1, bit value 1 is output from the AND circuit AND31 and bit value 0 is output from the AND circuit AND32. Consequently, bit value 1 is output from the exclusive OR circuit XOR21.

The case where the bit value E(0) is 1 is now described. When the bit value F(0) is 0, bit value 0 is output from the AND circuit AND31 and bit value 1 is output from the AND circuit AND32. Consequently, bit value 1 is output from the exclusive OR circuit XOR21. When the bit value F(0) is 1, bit value 0 is output from both of the AND circuits AND31 and AND32. Consequently, bit value 0 is output from the exclusive OR circuit XOR21.

As in the case described with reference to FIG. 13, if attention is focused on the first bit value transmitted to the exclusive OR circuit XOR21, the same bit value as the first bit value is output from the circuit when the second bit value transmitted to the circuit is 0, and the inverted bit value of the first bit value is output therefrom when the second bit value is 1.

The exclusive OR circuit XOR22 also has a circuit configuration to perform the same operation on two bit values transmitted to the circuit.

A truth table is shown for the three inputs and two outputs of the adder UCSA0 described with reference to FIGS. 13 and 14.

FIG. 15 shows a truth table showing combinations of bit values D(0), E(0), and F(0) received by the adder UCSA0 and a combination of bit values S(0) and C(1) output from the adder UCSA0 in accordance with each combination of the bit values D(0), E(0), and F(0). Shown in FIG. 15 is a truth table for the adder UCSA0 as an example; however, the truth tables for the other adders UCSA are the same.

[Operation Example]

An operation executed by the identification circuit 1 according to the first embodiment will be described. For example, the data generation processing by each node of the intermediate layer L1 of the neural network of the identification circuit 1 according to the first embodiment is implemented by the operation.

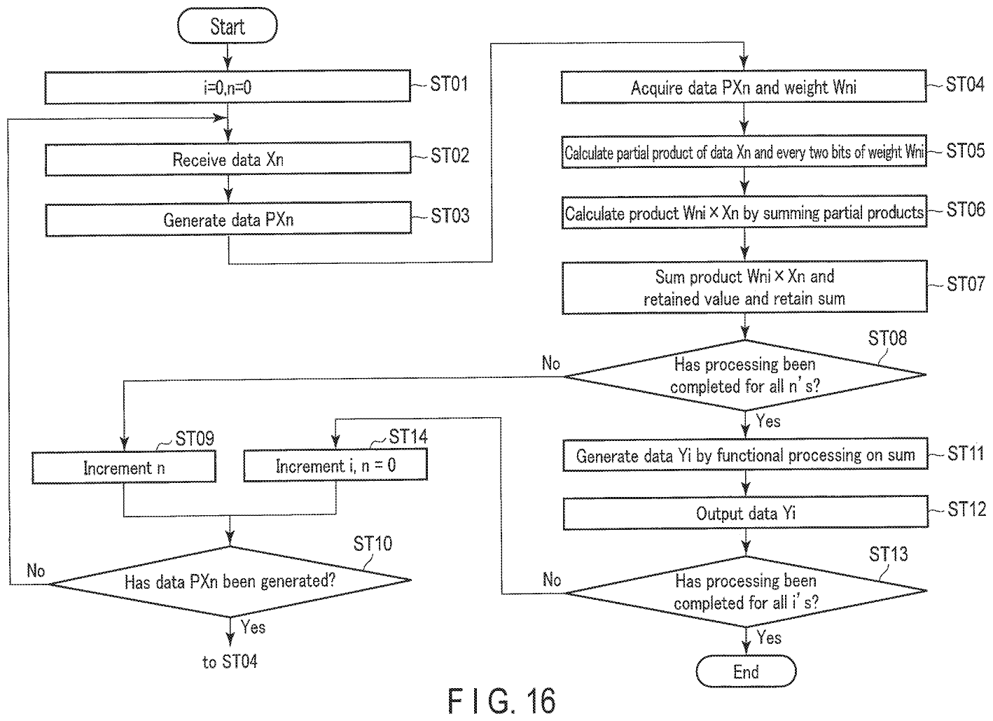

FIG. 16 is a flowchart showing an example of the operation executed by the identification circuit 1 according to the first embodiment. Hereinafter, n is an integer of 0 to 3.

In step ST01, the identification circuit 1 sets variable i to 0, and sets variable n to 0. The identification circuit 1 may set those variables together with the controller 3. The same applies to the other operations to be described below as being performed by the identification circuit 1.

In step ST02, the pre-calculation circuit 10 receives a data item Xn.

In step ST03, the pre-calculation circuit 10 generates a pre-calculated data item PXn based on the received data item Xn. At this point in time, the data item PX0 is generated. The pre-calculation circuit 10 transmits the generated data item PXn to the node processing circuit 20, for example.

In step ST04, the multiplier circuit 21 acquires the data item PXn and a weight Wni.

In step ST05, the partial product operation circuits 211-0, 211-2, . . . , and 211-22 calculate a partial product data item that represents a product of the value represented by the data item Xn and the value represented by every two adjacent bits of the weight Wni on the basis of the data item PXn and the weight Wni, and transmit the calculated partial product data items to the partial product adder circuit 212.

In step ST06, the partial product adder circuit 212 receives the partial product data items, sums the received partial product data items to calculate a product Wni×Xn, and transmits the product Wni×Xn to the adder circuit 22. The product Wni×Xn at this point in time is a product W00×X0.

Step ST07 is now described. The adder circuit 22 receives the product Wni×Xn from the multiplier circuit 21 and receives an output data item from the flip-flop circuit 23. The output data item from the flip-flop circuit 23 corresponds to the data item temporarily retained in the flip-flop circuit 23. The adder circuit 22 sums the product Wni×Xn and the output data item from the flip-flop circuit 23, and transmits the data item sum to the flip-flop circuit 23. The data item sum is temporarily retained in the flip-flop circuit 23. The output data item from the flip-flop circuit 23 at the point in time when the adder circuit 22 receives the first product from the multiplier circuit 21 for data generation processing at each node is, for example, a bit sequence in which the bits of all digits are represented by 0. Therefore, the data retained at this point in time is the product W00×X0.

In step ST08, the identification circuit 1 determines whether or not processing has been completed for all n's. At this point in time, processing has not been performed for the cases where n is 1, 2, and 3. When processing has not been completed for all n's as described above, the processing proceeds to step ST09.

In step ST09, the identification circuit 1 increments the value of n by 1. At this point in time, n is set to 1.

In step ST10, the identification circuit 1 determines whether or not the data item PXn has been generated. At this point in time, the data item PX1 has not been generated. When the data item PXn has not been generated, the processing returns to step ST02, and the operation from step ST02 to step ST07 is repeated.

By repeating steps ST02 to ST07, the data item PX1 is generated, and the sum (W00×X0+W10×X1) is temporarily retained in the flip-flop circuit 23. In steps ST08 and ST09, the identification circuit 1 increments the value of n by 1. At this point in time, n is set to 2. Since the data item PX2 has not been generated, the operation from step ST02 to step ST07 is repeated again based on the determination in step ST10.

By repeating steps ST02 to ST07, the data item PX2 is generated, and the sum (W00×X0+W10×X1+W20×X2) is temporarily retained in the flip-flop circuit 23. In steps ST08 and ST09, the identification circuit 1 increments the value of n by 1. At this point in time, n is set to 3. Since the data item PX3 has not been generated, the operation from step ST02 to step ST07 is repeated again based on the determination in step ST10.

By repeating steps ST02 to ST07, the data item PX3 is generated, and the sum (W00×X0+W10×X1+W20×X2+W30×X3) is temporarily retained in the flip-flop circuit 23.

In step ST08, it is determined that processing has been completed for all n's and, in such a case, the processing proceeds to step ST11.

Step ST11 is now described. The functional processing circuit 24 receives the sum (W0i×X0+W1i×X1+W2i×X2+W3i×X3) from the flip-flop circuit 23, and acquires the bias bi. At this point in time, the functional processing circuit 24 receives the sum (W00×X0+W10×X1+W20×X2×W30×X3). The functional processing circuit 24 substitutes the value of the sum (W0i×X0+W1i×X1+W2i×X2+W3i×X3+bi) obtained by summing the received sum and the bias bi for the variable x of the activation function f (x) to generate the data item Yi. At this point in time, the data item Y0 is generated.

In step ST12, the functional processing circuit 24 outputs the data item Yi. The data item Yi is output from the node processing circuit 20. At this point in time, the data item Y0 is output.

In step ST13, the identification circuit 1 determines whether or not processing has been completed for all i's. At this point in time, processing has not been performed for the cases where i is 1 and 2. When processing has not been completed for all i's as described above, the processing proceeds to step ST14.

In step ST14, the identification circuit 1 increments the value of i by 1, and sets n to 0 again. At this point in time, i is set to 1. After step ST14, the processing proceeds to step ST10.

In step ST10, the identification circuit 1 determines whether or not the data item PXn has been generated. At this point in time, the data item PX0 has been generated. When the data item PXn has been generated, the processing returns to step ST04. Namely, when the data item PXn has been generated, steps ST02 and ST03 in which the data item PXn is generated are omitted. Once the data item PXn is generated, the pre-calculation circuit 10 refrains from generating the data item PXn again until, for example, the flow described with reference to FIG. 16 finishes. In this case, the pre-calculation circuit 10 may also refrain from outputting the data item PXn again in this period.

After repeating the loop of steps ST04 to ST08, step ST09, and step ST10, the sum (W01×X0+W11×X1+W21×X2+W31×X3) is temporarily retained in the flip-flop circuit 23 as a result of step ST07 at a given point in time.

In step ST08, which follows step ST07, it is determined that processing has been completed for all n's and, in such a case, the processing proceeds to step ST11.

In step ST11, the data item Y1 is generated by the functional processing circuit 24, and the data item Y1 is output from the node processing circuit 20 in step ST12.

In steps ST13 and ST14, the identification circuit 1 increments the value of i by 1, and sets n to 0 again. At this point in time, i is set to 2. After step ST14, the processing proceeds to step ST10.

The same operation as in the case where i is set to 1 is repeated; as a result, the data item Y2 is output from the node processing circuit 20 in step ST12.

In step ST13, it is determined that processing has been completed for all i's, and the operation finishes.

Described above is an operation executed by the identification circuit 1; however, the above-described operation is merely an example. For example, the second and subsequent generations of the data item PXn in steps ST02 and ST03 executed by the pre-calculation circuit 10 may be executed in parallel with the processing in steps ST04 to ST07 executed by the node processing circuit 20. In addition, the setting order or the like of the variables i and n is not limited to the above-described one.

[Advantageous Effects]

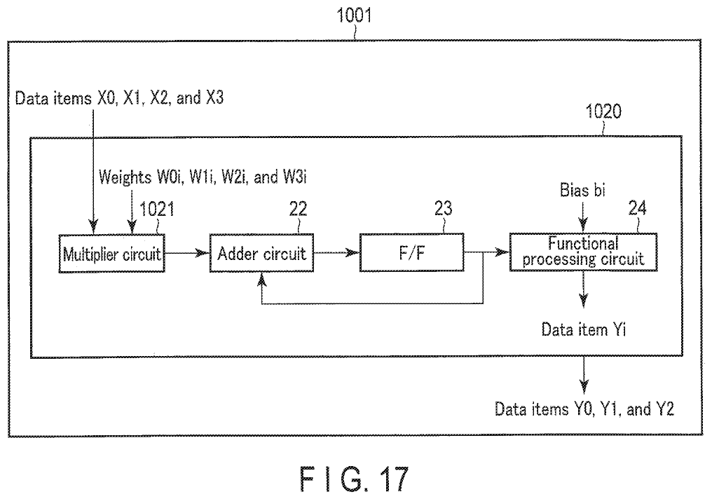

An identification circuit 1001 according to a comparative example is now described. FIG. 17 is a block diagram showing an example of the configuration of the identification circuit 1001 according to the comparative example. The identification circuit 1001 does not include the pre-calculation circuit 10 described in connection with the first embodiment with reference to FIG. 4. The identification circuit 1001 includes a circuit 1021 instead of the multiplier circuit 21.

The multiplier circuit 1021 calculates the product W0i×X0 based on the data item X0 and the weight W0i. Similarly, the multiplier circuit 1021 calculates the product W1i×X1 based on the data item X1 and the weight W1i. The multiplier circuit 1021 also calculates the product. W2i×X2 based on the data item X2 and the weight W2i. Furthermore, the multiplier circuit 1021 calculates the product W3i×X3 based on the data item X3 and the weight W3i. For all the cases where i is 0, 1, and 2, the multiplier circuit 1021, the adder circuit 22, the flip-flop circuit 23, and the functional processing circuit 24 repeat processing. Accordingly, the data items Y0, Y1, and Y2 are generated.

A multiplication method used for each of such multiplications by the multiplier circuit 1021 is now described. A multiplication of a 4-bit data item A[3:0] and a 4-bit data item B[3:0] is described as an example. In the multiplication method, a product. A[3:0]×B[3:0] is calculated by summing partial products Q0, Q1, Q2, and Q3 described below.

The partial product Q0 is a product A[3:0]×B[0]. The partial product Q0 is a bit sequence that represents a value obtained by multiplying the value of the data item A[3:0] by B(0) and further multiplying the resultant value by 2⁰. B(0) is one of 0 and 1.

The partial product Q1 is a product A[3:0]×B[1]. The partial product Q1 is a bit sequence that represents a value obtained by multiplying the value of the data item. A[3:0] by B(1) and further multiplying the resultant value by 2¹. B(1) is also one of 0 and 1.

Similarly, the partial product Q2 is a bit sequence that represents a value obtained by multiplying the value of the data item A[3:0] by B (2) and further multiplying the resultant value by 2², and the partial product Q3 is a bit sequence that represents a value obtained by multiplying the value of the data item. A[3:0] by B(3) and further multiplying the resultant value by 2³.

Accordingly, a series of bit values included in each partial product Q is the same as a series of bit values included in the bit sequence that represents one of the zerofold value and onefold value of the value of the data item A[3:0]. Which of the zerofold value and onefold value the bit sequence represents is based on the bit value of one bit used for calculating each partial product Q of the data item B[3:0].

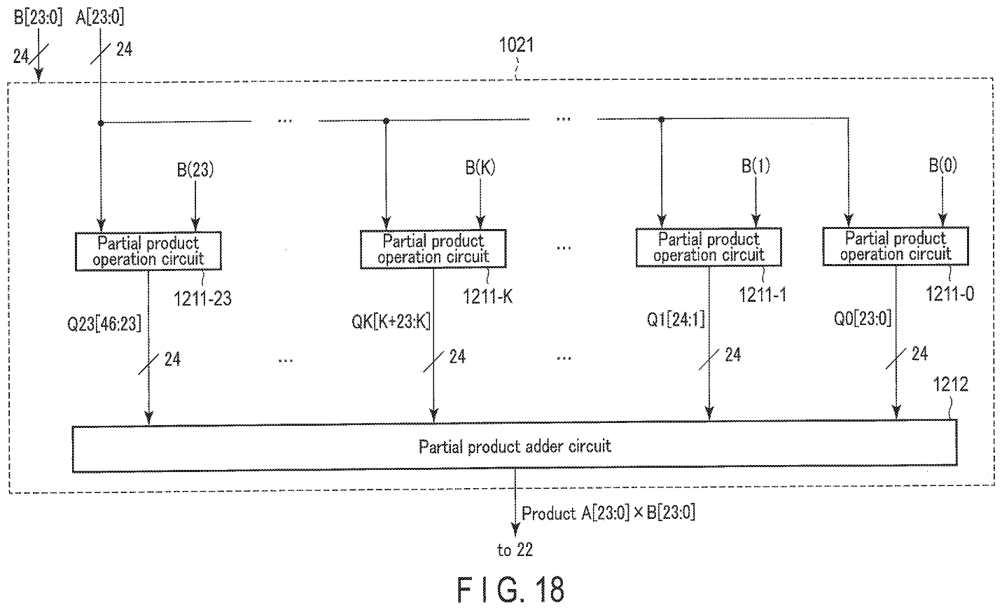

FIG. 18 is a block diagram showing an example of the configuration of the multiplier circuit 1021 of the identification circuit 1001 according to the comparative example.

The multiplier circuit 1021 includes partial product operation circuits 1211-0, 1211-1, 1211-2, . . . , and 1211-23 and a partial product adder circuit 1212. For each of the cases where k is integers from 0 to 23, the partial product operation circuit 1211-k receives a bit value B(k), and calculates a partial product data item Qk[k+23:k], which represents a value obtained by multiplying the value of the data item A[23:0] by B(k) and further multiplying the resultant value by 2^{k}, based on the data item A[23:0] and the bit value B(k). The partial product adder circuit 1212 receives the partial product data item Qk[k+23:k] for each of the cases where k is integers from 0 to 23. The partial product adder circuit 1212 sums the received, partial product data items to generate the product A[23:0]×B[23:0].

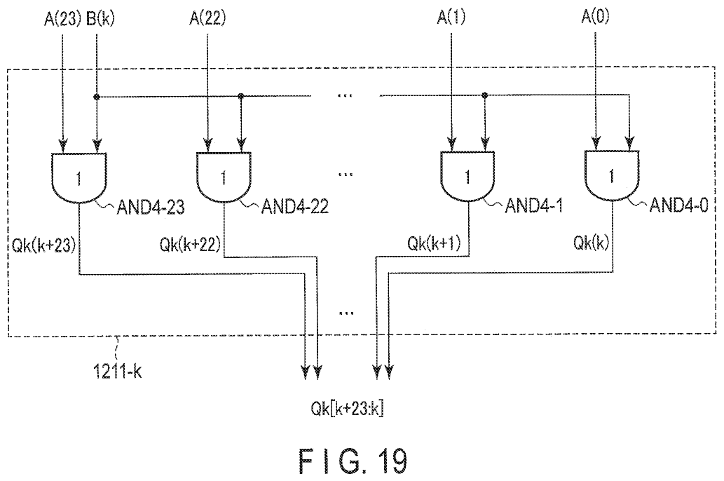

FIG. 19 shows an example of the circuit configuration of the partial product operation circuit 1211-k in the multiplier circuit 1021 of the identification circuit 1001 according to the comparative example. The partial product operation circuit 1211-k includes AND circuits AND4-0, AND4-1, . . . , and AND4-23. For each of the cases where h is integers from 0 to 23, the AND circuit AND4-h receives a bit value A(h) on the first input terminal and receives a bit value B(k) on the second input terminal. In this way, the bit values of the 24 digits of the data item A[23:0] are transmitted to the first input terminals of the AND circuits AND4-0, AND4-1, . . . , and AND4-23.

A set of the bit value Qk(k) output from the AND circuit AND4-0, the bit value Qk(k+1) output from the AND circuit AND4-1, . . . , and the bit value Qk(k+23) output from the AND circuit AND4-23 is the partial product data item Qk[k+23:k] described with reference to FIG. 18.

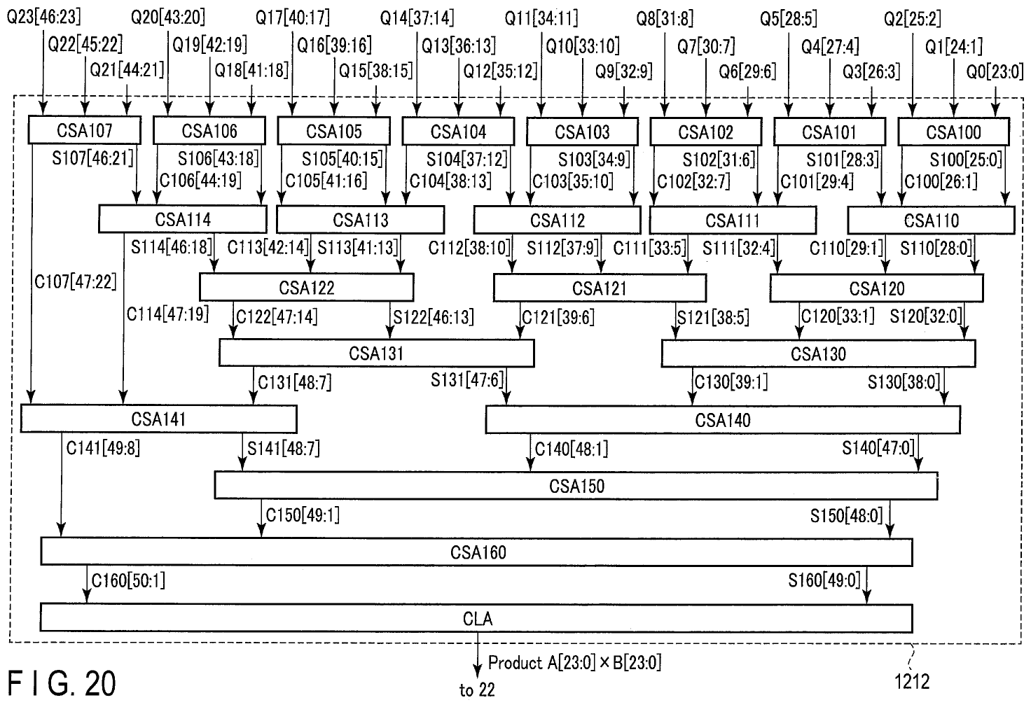

FIG. 20 is a block diagram showing an example of the configuration of the partial product adder circuit 1212 in the multiplier circuit 1021 of the identification circuit 1001 according to the comparative example. The partial product adder circuit 1212 has a so-called Wallace tree structure. Based on the multiplication method described with reference to FIG. 17 and the partial product operation by the partial product operation circuit 1211 described with reference to FIG. 18, the partial product adder circuit 1212 requires the configuration shown in FIG. 20. Namely, the partial product adder circuit 1212 includes carry-save adders CSA100, CSA101, CSA102, CSA103, CSA104, CSA105, CSA106, CSA107, CSA110, CSA111,CSA112, CSA113, CSA114, CSA120, CSA121, CSA122, CSA130,CSA131, CSA140, CSA141, CSA150, and CSA160, and a carry lookahead adder CLA. With this configuration, the adder CLA can generate the product A[23:0]×B[23:0].

As described above in detail, the multiplier circuit 21 of the identification circuit 1 according to the first embodiment and the multiplier circuit 1021 of the identification circuit 1001 according to the comparative example both receive the data item A[23:0], and generate and output the product A[23:0]×B[23:0].

However, the identification circuit 1 according to the first embodiment and the identification circuit 1001 according to the comparative example perform different processing to output the same data item, and thus consume different powers. The magnitude relationship between the consumed powers can be estimated based on, for example, the difference in the total number of AND operations and OR operations performed in relevant circuits.

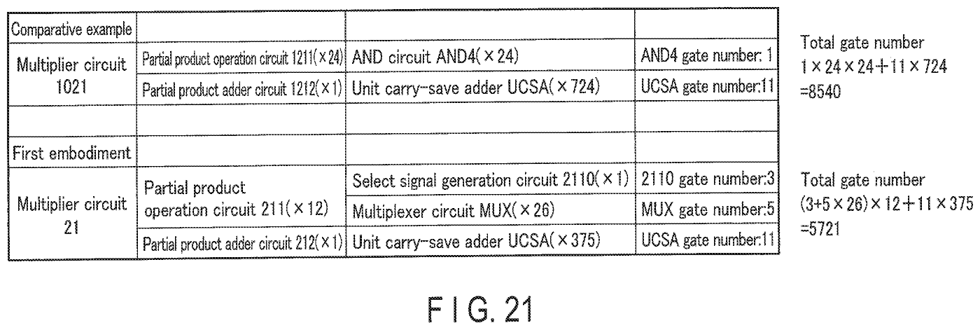

FIG. 21 is an exemplary table showing the roughly estimated number of AND circuits and OR circuits (hereinafter also referred to “as the number of gates”) included in each of the multiplier circuit 1021 of the identification circuit 1001 according to the comparative example and the multiplier circuit 21 of the identification circuit 1 according to the first embodiment for examination of the magnitude relationship of the consumed powers.

First, the number of gates in the circuits of the multiplier circuit 1021 of the identification circuit 1001 according to the comparative example, which are different from those of the multiplier circuit 21 of the identification circuit 1 according to the first embodiment, is counted. In each figure referred to in the following description, the number of gates included in each of the AND circuits, OR circuits, and circuits including an AND circuit and/or an OR circuit is indicated in the symbol of the circuit block.

As described with reference to FIG. 18, the multiplier circuit 1021 of the identification circuit 1001 according to the comparative example includes 24 partial product operation circuits 1211 and a partial product adder circuit 1212.

As described with reference to FIG. 19, each partial product operation circuit 1211 includes 24 AND circuits (24 gates in total).

In sum, the total number of gates of the 24 partial product operation circuits is 24×24=576.

As described with reference to FIG. 20, the partial product adder circuit 1212 includes, for example, carry-save adders CSA100, CSA101, CSA102, CSA103, CSA104, CSA105, CSA106, CSA107, CSA110, CSA111, CSA112, CSA113, CSA114, CSA120, CSA121, CSA122, CSA130, CSA131, CSA140, CSA141, CSA150, and CSA160, and a Carry lookahead adder CLA.

Three data items received by an adder CSA are each constituted by a plurality of bits of digits in a certain range. As described with reference to FIG. 12, the adder CSA includes a unit carry-save adder UCSA for each of the digits from the minimum digit to the maximum digit of the three ranges. As described with reference to FIG. 13, each adder UCSA includes three AND circuits, two OR circuits, and two exclusive OR circuits. As described with reference to FIG. 14, one exclusive OR circuit includes, for example, two AND circuits and one OR circuit. Namely, the number of gates of each adder UCSA is 3+2+3×2=11.

The adder CSA100 includes 26 adders UCSA for the respective 0th to 25th digits. Similarly, the adders CSA101, CSA102, CSA103, CSA104, CSA105, CSA106, and CSA107 each include 26 adders UCSA. The adders CSA110, CSA111, CSA112, CSA113, and CSA114 each include 29 adders UCSA. The adder CSA120 includes 33 adders UCSA, the adder CSA 121 includes 34 adders UCSA, and the adder CSA122 includes 34 adders UCSA. The adder CSA130 includes 39 adders UCSA, and the adder CSA131 includes 42 adders UCSA. The adder CSA140 includes 48 adders UCSA, and the adder CSA141 includes 42 adders UCSA. The adder CSA150 includes 49 adders UCSA. The adder CSA160 includes 50 adders UCSA.

The carry lookahead adder CLA in the partial product adder circuit 1212 processes the bits of the digits in the same range as those processed by the adder CLA in the partial product adder circuit 212 in the multiplier circuit 21 of the identification circuit 1 according to the first embodiment. Therefore, the number of gates of the adder CLA is excluded from the comparison objects when the difference in consumed power is estimated as described above.

In sum, the partial product adder circuit 1212 includes, for example, 26×8+29×5+33+34+34+39+42+48+42+49+50=724 adders UCSA. In this case, the total number of the gates of all the adders UCSA in the partial product adder circuit 1212 is 11×724=7964.

Accordingly, the number of gates in the circuits of the multiplier circuit 1021 of the identification circuit 1001 according to the comparative example, which are different from those of the multiplier circuit 21 of the identification circuit 1 according to the first embodiment, is roughly estimated to be 576+7964=8540.

Next, the number of gates in the circuits of the multiplier circuit 21 of the identification circuit 1 according to the first embodiment, which are different from those of the multiplier circuit 1021 of the identification circuit 1001 according to the comparative example, is counted.

As described with reference to FIG. 7, the multiplier circuit 21 of the identification circuit 1 according to the first embodiment includes 12 partial product operation circuits 211 and a partial product adder circuit 212.

As described with reference to FIG. 8, each partial product operation circuit 211 includes a select signal generation circuit 2110 and 26 multiplexer circuits MUX.

As described with reference to FIG. 9, the select signal generation circuit 2110 includes three AND circuits. As described with reference to FIG. 9, each multiplexer circuit MUX includes three AND circuits and two OR circuits (five gates in total).

In sum, the total number of gates of the 12 partial product operation circuits is (3+5×26)×12=1596.

As described with reference to FIG. 11, the partial product adder circuit 212 includes, for example, carry-save adders CSA00, CSA01, CSA02, CSA03, CSA10, CSA11, CSA20, CSA21, CSA30, and CSA40, and a carry lookahead adder CLA.

The adders CSA00, CSA01, CSA02, and CSA03 each include 30 adders UCSA. The adders CSA10 and CSA11 each include 36 adders UCSA. The adder CSA20 includes 43 adders UCSA, and the adder CSA21 includes 41 adders UCSA. The adder CSA30 includes 49 adders UCSA. The adder CSA40 includes 50 adders UCSA.

In sum, the partial product adder circuit 212 includes, for example, 30×4+36×2+43+41+49+50=375 adders UCSA. In this case, the total number of the gates of all the adders UCSA in the partial product adder circuit 212 is 11×375=4125.

Accordingly, the total number of gates in the circuits of the multiplier circuit 21 of the identification circuit 1 according to the first embodiment, which are different from those of the multiplier circuit 1021 of the identification circuit 1001 according to the comparative example, is roughly estimated to be 1596+4125=5721.

The identification circuit 1 according to the first embodiment includes the pre-calculation circuit 10, which is not included in the identification circuit 1001 according to the comparative example.

As described with reference to FIG. 17, in the identification circuit 1001 according to the comparative example, the multiplier circuit 1021 performs multiplication processing using a received data item the same number of times as the number (m for the sake of convenience) of nodes of the intermediate layer L1. In the multiplication processing performed m times by the multiplier circuit 1021, m operations are performed in each of the AND circuits and OR circuits counted for the multiplier circuit 1021.

In contrast, as described with reference to FIG. 4, in the identification circuit 1 according to the first embodiment, the pre-calculation circuit 10 generates a pre-calculated data item based on a received data item, and the multiplier circuit 21 performs multiplication processing, in which the pre-calculated data item is used, m times. In the pre-calculated data item generation processing performed once by the pre-calculation circuit 10, one operation is performed in each of the AND circuits and OR circuits included in the pre-calculation circuit 10. In the multiplication processing performed m times by the multiplier- circuit 21, m operations are performed in each of the AND circuits and OR circuits counted for the multiplier circuit 21.

Therefore, in the above-described processing for receiving a data item and performing multiplications using the .data item, the multiplier circuit 1021 of the identification circuit 1001 according the comparative example performs 8540×m AND and/or OR operations, and the pre-calculation circuit 10 and multiplier circuit 21 of the identification circuit 1 according to the first embodiment perform (the number of gates of the pre-calculation circuit 10)+5721×m AND and/or OR operations.

Therefore, in relation to the circuits for which the number of the gates is counted above, the identification circuit 1 according to the first embodiment can reduce power by {1−((the number of gates of the pre-calculation circuit 10)+5721×m)/(540×m)}×100% in comparison with the identification circuit 1001 according to the comparative example. As m increases, the power to be reduced increases and gets closer to, for example, 33%.

For example, when one pre-calculation circuit 10 and node processing circuits 20 equal in number to the nodes are prepared for each layer as described with reference to FIG. 4, a circuit size of the same ratio as the above-described one may be reduced in regard to the circuits for which the nu the of gates is counted above. Accordingly, the identification circuit 1 according to the first embodiment may enable reduction in the circuit size.

### Second Embodiment

Hereinafter, an identification circuit 1 according to a second embodiment will be described. The identification circuit 1 according to the second embodiment may execute the same operation as the one described in connection with the identification circuit 1 according to the first embodiment, and may produce the same advantageous effects as the ones described in the first embodiment.

A configuration of the identification circuit 1 according to the second embodiment will be described, focusing on differences from the configuration of the identification circuit 1 according to the first embodiment.

The identification circuit 1 according to the second embodiment has the same configuration as that of the identification circuit 1 according to the first embodiment described with reference to FIGS. 1 to 7 and 11 to 15.

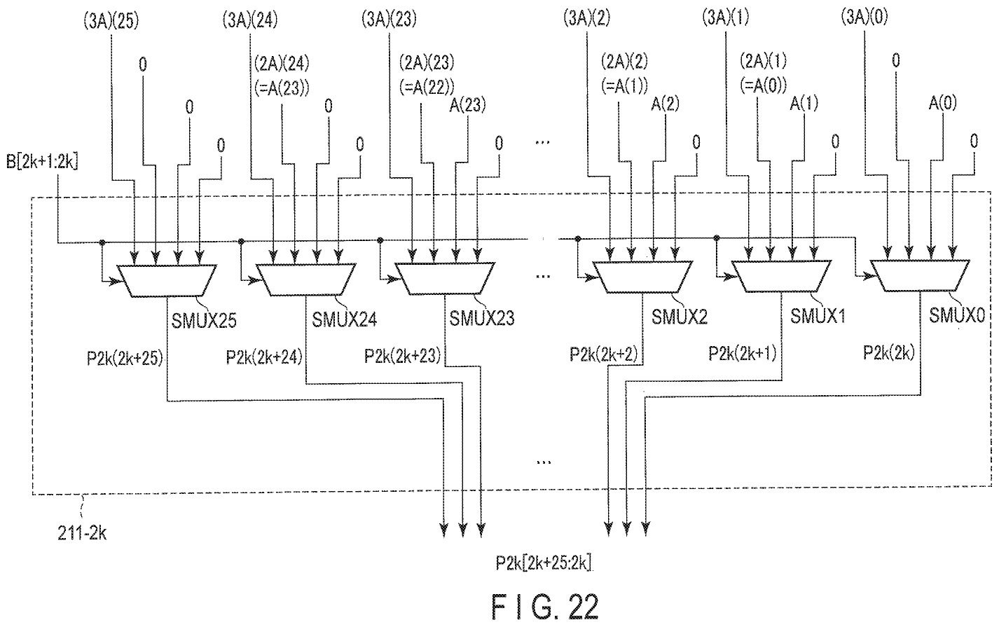

FIG. 22 shows an example of the circuit configuration of the partial product operation circuit 211-2k in the multiplier circuit 21 of the identification circuit 1 according to the second embodiment.

The configuration of the partial product operation circuit 211-2k may be different from that described in connection with the first embodiment with reference to FIG. 8 in the following respects.

The partial product operation circuit 211-2k does not include, for example, the select signal generation circuit 2110 described in connection with the first embodiment with reference to FIG. 8.

The partial product operation circuit 211-2k includes multiplexer circuits SMUX0, SMUX1, SMUX2, . . . , and SMUX25 instead of the multi lexer circuits MUX0, MUX1, MUX2, . . . , and MUX25 described in connection with the first embodiment with reference to FIG. 8. Each multiplexer circuit SMUX includes, for example, a first input terminal, a second input terminal, a third input terminal, and a fourth input terminal. Hereinafter, g is an integer of 0 to 25. The following description applies to each of the cases where g is integers from 0 to 25.

The multiplexer circuit SMUXg receives, on the first input terminal, the bit value described as being received by the multiplexer circuit MUXg on the first input terminal with reference to FIG. 8. Similarly, the multiplexer circuit SMUXg receives, on the second input terminal, the bit value described as being received by the multiplexer circuit MUXg on the second input terminal, receives, on the third input terminal, the bit value described as being received by the multiplexer circuit MUXg on the third input terminal, and receives, on the fourth input terminal, the bit value described as being received by the multiplexer circuit MUXg on the fourth input terminal.

Each multiplexer circuit SMUX receives, for example, the data item B[2k+1:2k]. Upon receipt of the data item B[2k+1:2k], each multiplexer circuit SMUX executes the next processing.

When each of the bit values B(2k+3) and B(2k) is 0, i.e., when 2×B(2k+1)+B(2k) is 0, each multiplexer circuit SMUX outputs, on the output terminal, the bit value received on the first input terminal of the multiplexer circuit SMUX.

When the bit value B (2k+1) is 0 and the bit value B(2k) is 1, i.e., when 2×B (2k+1)+B(2k) is 1, each multiplexer circuit SMUX outputs, on the output terminal, the bit value received on the second input terminal of the multiplexer circuit SMUX.

When the bit value B(2k+1) is 1 and the bit value B(2k) is 0, i.e., when 2×B (2k+1)+B(2k) is 2, each multiplexer circuit SMUX outputs, on the output terminal, the bit value received on the third input terminal of the multiplexer circuit SMUX.

When each of the bit values B(2k+1) and B(2k) is 1, i.e., when 2×B(2k+1)+B(2k) is 3, each multiplexer circuit SMUX outputs, on the output terminal, the bit value received on the fourth input terminal of the multiplexer circuit SMUX.

In this way, the bit values output from the multiplexer circuits SMUX0, SMUX1, SMUX2, . . . , SMUX23, SMUX24, and SMUX25 in response to the data item B[2k+1:2k] are output as bit values P2k(2k), P2k(2k+1), P2k(2k+2), . . . , P2k(2k+23), P2k(2k+24), and P2k(2k+25), respectively. A set of these bit values P2k(2k), P2k(2k+1), P2k(2k+2), . . . , P2k(2k+23), P2k(2k+24), and P2k(2k+25) is the partial product data item P2k[2k+25:2k] described with reference to FIG. 7.

It can be understood that, when the partial product data item P2k[2k+25:2k] is output, a bit sequence that represents a value obtained by multiplying the value of the data item A[23:0] by {2×B(2k+1)+B(2k)} and further multiplying the resultant value by 2^{2k} is output as in the case described with reference to FIG. 6.

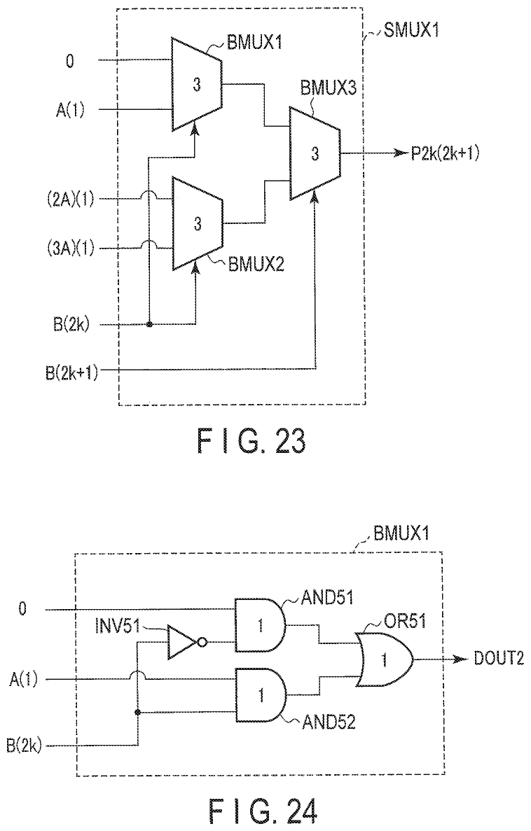

FIG. 23 shows an example of the circuit configuration of the multiplexer circuit SMUX1 of the identification circuit 1 according to the second embodiment. Each of the other multiplexer circuits SMUX may have the same circuit configuration.

The multiplexer circuit SMUX1 includes, for example, multiplexers BMUX1, BMUX2, and BMUX3. Each multiplexer B1VIUX includes a first input terminal, a second input terminal, and a third input terminal.

Each bit value described as being received by the multiplexer circuit SMUX1 with reference to FIG. 22 is processed in the multiplexer circuit SMUX1 as follows.

The multiplexer BMUX1 receives bit value 0 on the first input terminal, receives the bit value A(1) on the second input terminal, and receives the bit value B(2k) on the third input terminal.

The multiplexer BMUX2 receives the bit value (2A)(1) on the first input terminal, receives the bit value (3A) (1) on the second input terminal, and receives the bit value B(2k) on the third input terminal.

When the bit value B(2k) is 0, the multiplexers BMUX1 and BMUX2 each output, on the output terminal, the bit value received on the first input terminal, and when the bit value B(2k) is 1, the multiplexers BMUX1 and BMUX2 each output, on the output terminal, the bit value received on the second input terminal.

The multiplexer BMUX3 receives, on the first input terminal, the bit value output from the multiplexer BMUX1, receives, on the second input terminal, the bit value output from the multiplexer BMUX2, and receives, on the third input terminal, the bit value B(2k+1) on the third input terminal.

When the bit value B(2k+1) is 0, the multiplexer BMUX3 outputs, on the output terminal, the bit value received on the first input terminal, and when the bit value B(2k+1) is 1, the multiplexer BMUX3 outputs, on the output terminal, the bit value received on the second input terminal. The output bit value is the bit value P2k(2k+1).

Accordingly, when the bit value B(2k) is 0, bit value 0 is output from the multiplexer BMUX1 and the bit value (2A) (1) is output from the multiplexer BMUX2. In this case, the bit value P2k(2k+1) output from the multiplexer BMUX3 is bit value 0 when the bit value B(2k+1) is 0, and is the bit value (2A) (1) when the bit value B(2k+1) is 1.

Similarly, when the bit value B(2k) is 1, the bit value A(1) is output from the multiplexer BMUX1 and the bit value (3A) (1) is output from the multiplexer BMUX2. In this case, the bit value P2k(2k+1) output from the multiplexer BMUX3 is the bit value A(1) when the bit value B(2k+1) is 0, and is the bit value (3A) (1) when the bit value B(2k+1) is 1.

Each of the other multiplexer circuits SMUX is also configured to perform the same operations for the respective combinations of the bit values B(2k) and B(2k+1).

By configuring each multiplexer circuit SMUX as described above, the output from each multiplexer circuit SMUX in response to the data item B[2k+1:2k] as described with reference to FIG. 22 may be implemented.

FIG. 24 shows an example of the circuit configuration of the multiplexer BMUX1 shown in FIG. 23. The other multiplexers BMUX2 and BMUX3 may have the same circuit configuration.

The multiplexer BMUX1 includes, for example, an inverter INV51, AND circuits AND51 and AND52, and an OR circuit OR51.

Each bit value described as being received by the multiplexer BMUX1 with reference to FIG. 23 is processed in the multiplexer BMUX1 as follows.

The AND circuit AND51 receives bit value 0 on the first input terminal and receives, on the second input terminal, a value obtained by inverting the bit value B(2k) through the inverter INV51.

The AND circuit AND52 receives the bit value A(1) on the first input terminal, and receives the bit value B(2k) on the second input terminal.

Each of the AND circuits AND51 and AND52 performs an AND operation on the bit value received on the first input terminal and the bit value received on the second input terminal, and outputs, on the output terminal, a bit value which is a result of the operation.

The OR circuit OR51 receives, on the first input terminal, the bit value output; from the AND circuit AND51 and receives, on the second input terminal, the bit value output from the AND circuit AND52. The OR circuit OR51 performs an OR operation on the two received bit values, and outputs, on the output terminal, a bit value which is a result of the operation. The bit value shown as DOUT2 in FIG. 24 is output from the multiplexer BMUX1.

Hereinafter, the bit value of DOUT2 will be described.

When the bit value B(2k) is 0, the bit value received by the AND circuit AND51 on the first input terminal is output from the AND circuit AND51 and bit value 0 is output from the AND circuit AND52. Consequently, the bit value of DOUT2 output from the multiplexer BMUX1 is the bit value received by the AND circuit AND51 on the first input terminal, i.e., bit value 0. In contrast, when the bit value B(2k) is 1, bit value 0 is output from the AND circuit AND51 and the bit value received by the AND circuit AND52 on the first input terminal is output from the AND circuit AND52. Consequently, the bit value of DOUT2 output from the multiplexer BMUX1 is the bit value received by the AND circuit AND52 on the first input terminal, i.e., the bit value A(1).

As described with reference to FIG. 23, when the bit value B(2k) is 0, the bit value received by the multiplexer BMUX1 on the first input terminal is output from the multiplexer BMUX1, and when the bit value B(2k) is 1, the bit value received by the multiplexer BMUX1 on the second input terminal is output from the multiplexer BMUX1.

The multiplexer BMUX2 also has a circuit configuration to perform the same operation when the bit value B(2k) is 0 and when the bit value B(2k) is 1. The multiplexer BMUX3 has a circuit configuration to perform the same operation when the bit value B(2k+1) is 0 and when the bit value B(2k+1) is 1.

As described above in detail, the multiplier circuit 21 of the identification circuit 1 according to the second embodiment and the multiplier circuit 1021 of the identification circuit 1001 according to the comparative example both receive the data item A[23:0], and generate and output the product A[23:0]×B[23:0].

However, the identification circuit 1 according to the second embodiment and the identification circuit 1001 according to the comparative example perform different processing to output the same data item, and thus consume different powers.

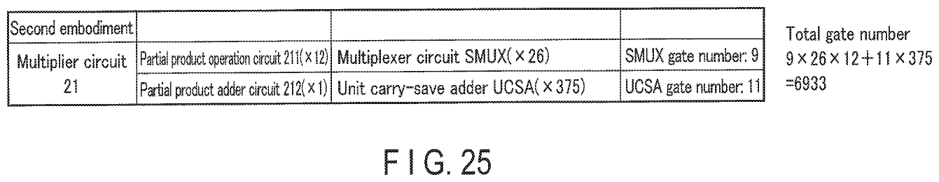

FIG. 25 is an exemplary table showing the roughly estimated number of gates included in the multiplier circuit 21 of the identification circuit 1 according to the second embodiment for examination of the magnitude relationship of the consumed powers.

The number of gates in the circuits of the multiplier circuit 21 of the identification circuit 1 according to the second embodiment, which are different from those of the multiplier circuit 1021 of the identification circuit 1001 according to the comparative example, is counted.

As described with reference to FIG. 7, the multiplier circuit 21 of the identification circuit 1 according to the second embodiment includes 12 partial product operation circuits 211 and a partial product adder circuit 212.

As described with reference to FIG. 22, each partial product operation circuit 211 includes 26 multiplexer circuits SMUX.

As described with reference to FIG. 23, each multiplexer circuit SMUX includes three multiplexers BMUX, for example. As described with reference to FIG. 24, each multiplexer BMUX includes two AND circuits and one OR circuit (three gates in total). Namely, the number of gates of each multiplexer circuit SMUX is 3×3=9.

In sum, the total number of gates of the 12 partial product operation circuits is 9×26×12=2808.

Regarding the partial product adder circuit 212, the same description as that in the first embodiment applies. For example, as described with reference to FIG. 11 in connection with the first embodiment, the total number of gates of all the adders UCSA in the partial prod circuit 212 is 4125.

Accordingly, the total number of gates in the circuits of the multiplier circuit 21 of the identification circuit 1 according to the second embodiment, which are different from those of the multiplier circuit 1021 of the identification circuit 1001 according to the comparative example, is roughly estimated to be 2808+4125=6933.

The identification circuit 1 according to the second embodiment also includes the pre-calculation circuit 10, which is not included in the identification circuit. 1001 according to the comparative example.

As described with reference to FIG. 4, also in the identification circuit 1 according to the second embodiment, the pre-calculation circuit 10 generates a pre-calculated data item based on a received data item, and the multiplier circuit 21 performs multiplication processing, in which the pre-calculated data item is used, m times. In the pre-calculated data item generation processing performed once by the pre-calculation circuit 10, one operation is performed in each of the AND circuits and OR circuits included in the pre-calculation circuit 10. In the multiplication processing performed m times by multiplier circuit 21, m operations are performed in each of the AND circuits and OR circuits counted for the multiplier circuit 21.

Therefore, in the above-described processing for receiving a data item and performing multiplications using the data item, the multiplier circuit 1021 of the identification circuit 1001 according to the comparative example performs 8540×m AND and/or OR operations, and the pre-calculation circuit 10 and multiplier circuit 21 of the identification circuit 1 according to the second embodiment perform (the number of gates of the pre-calculation circuit 10)+6933×m operations.

Therefore, in relation to the circuits for which the number of the gates is counted above, the identification circuit 1 according to the second embodiment can reduce power by {1−((the number of gates of the pre-calculation circuit 10)+6933×m)/(8540×m)}×100% in comparison with the identification circuit 1001 according to the comparative example. As m increases, the power to be reduced increases and gets closer to, for example, 19%. In addition, as described in connection with the first embodiment, the identification circuit 1 according to the second embodiment may enable reduction in the circuit size.

<Other Embodiments>

Herein, if expressions such as “the same”, “correspond”, “constant”, “maintain”, etc. are used, variations in the range of design may be tolerated.

Herein, the term “couple” refers to electrical coupling, and does not exclude intervention of another component.

Described in the above embodiments are the cases where the multiplier circuit is provided with a partial product operation circuit prepared for every two bits of the data item B. However, the present embodiments are riot limited to those cases. The multiplier circuit may be provided with a partial product operation circuit prepared for each set of two bits of the data item B, as well as a partial product operation circuit prepared for each bit of the other bits of the data item B as described in connection with the comparative example. The partial product operation circuits prepared for respective sets of two bits of the data item B may be a combination of a partial product operation circuit having the configuration described in connection with the first embodiment and that having the configuration described in connection with the second embodiment.

While certain. embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A neural network device comprising:
a first circuit configured to receive a first bit sequence representing a first value and output a second bit sequence representing a threefold value of the first value; and
a second circuit configured to:
receive the first bit sequence and the second bit sequence;
receive a third bit sequence representing a second value, generate a fourth bit sequence based on the first bit sequence, the second bit sequence, and first and second bits of adjacent digits of the third bit sequence, and output a fifth bit sequence representing a product of the first value and the second value based on the fourth bit sequence; and
receive a sixth bit sequence representing a third value, generate a seventh bit sequence based on the first bit sequence, the second bit sequence, and third and fourth bits of adjacent digits of the sixth bit sequence, and output an eighth bit sequence representing a product of the first value and the third value based on the seventh bit sequence.

2. The device according to claim 1, wherein
the fourth bit sequence represents a product of the first value and a value represented by the first and second bits, and
the seventh bit sequence represents a product of the first value and a value represented by the third and fourth bits.

3. The device according to claim 1, wherein
each of the fourth bit sequence and the seventh bit sequence includes one of the first bit sequence and the second bit sequence, or consists of bit values 0.

4. The device according to claim 3, wherein
when a bit value of one of the first bit and the second bit is 1, and a bit value of other one of the first bit and the second bit is 0, the fourth bit sequence includes the first bit sequence, and
when bit values of both of the first bit and the second bit are 1, the fourth bit sequence includes the second bit sequence.

5. The device according to claim 2, wherein
the second circuit is further configured to, based on the first bit sequence, the second bit sequence, and fifth and sixth bits of adjacent digits of the third bit sequence, generate a ninth bit sequence representing a product of the first value and a value represented by the fifth and sixth bits, and
the fifth bit sequence is generated by summing the fourth bit sequence and the ninth bit sequence.

6. The device according to claim 1, wherein
the first circuit is further configured to receive a ninth bit, sequence representing a fourth value and output a tenth bit sequence representing a threefold value of the fourth value, and
the second circuit is further configured to:
receive the ninth bit sequence and the tenth bit sequence;
receive an eleventh bit sequence representing a fifth value, generate a twelfth bit sequence based on the ninth bit sequence, the tenth bit sequence, and fifth and sixth bits of adjacent digits of the eleventh bit sequence, and output a thirteenth bit sequence representing a product of the fourth value and the fifth value based on the twelfth bit sequence; and
receive a fourteenth bit sequence representing a sixth value, generate a fifteenth bit sequence based on the ninth bit sequence, the tenth bit sequence, and seventh and eighth bits of adjacent digits of the fourteenth bit sequence, and output a sixteenth bit sequence representing a product of the fourth value and the sixth value based on the fifteenth bit sequence, and
the neural network device further comprises a third circuit configured to:
receive the fifth bit sequence and the thirteenth bit sequence and output, based on the fifth bit sequence and the thirteenth bit sequence, a seventeenth bit sequence representing a sum of the product of the first value and the second value and the product of the fourth value and the fifth value; and
receive the eighth bit sequence and the sixteenth bit sequence and output, based on the eighth bit sequence and the sixteenth bit sequence, an eighteenth bit sequence representing a sum of the product of the first value and the third value and the product of the fourth value and the sixth value.

7. The device according to claim 1, further comprising a third circuit configured to:
receive the fifth bit sequence and output a ninth bit sequence based on the fifth bit sequence; and
receive the eighth bit sequence and output a tenth bit sequence based on the eighth bit sequence,
wherein
the second circuit is further configured to:
receive the ninth bit sequence and an eleventh bit sequence and output a twelfth bit sequence representing a product of a value represented by the ninth bit sequence and a value represented by the eleventh bit sequence; and
receive the tenth bit sequence and a thirteenth bit sequence and output a fourteenth bit sequence representing a product of a value represented by the tenth bit sequence and a value represented by the thirteenth bit sequence, and
the third circuit is further configured to receive the twelfth bit sequence and the fourteenth bit sequence and output a fifteenth bit sequence based on the twelfth bit sequence and the fourteenth bit sequence.

8. The device according to claim 1, wherein
the first circuit is further configured to, after outputting the second bit sequence, refrain from outputting the second bit sequence until the second circuit outputs the fifth bit sequence and outputs the eighth bit sequence.

9. The device according to claim 1, wherein the third bit sequence and the sixth bit sequence are each learned based on training data.

10. A neural network system comprising the device according to claim 1, wherein
the neural network system is configured to receive first data,
the first bit sequence is based on the first data, and
the neural network system is further configured to output second data indicating an identification result of the first data, based on the fifth bit sequence and the eighth bit sequence.

11. An operation method executed by a neural network device, comprising:
generating, based on a first bit sequence representing a first value, a second bit sequence representing a threefold value of the first value;
generating a fourth bit sequence based on the first bit sequence, the second bit sequence, and first and second bits of adjacent digits of a third bit sequence representing a second value;
generating, based on the fourth bit sequence, a fifth bit sequence representing a product of the first value and the second value;
generating a seventh bit sequence based on the first bit sequence, the second bit sequence, and third and fourth bits of adjacent digits of a sixth bit sequence representing a third value; and
generating, based on the seventh bit sequence, an eighth bit sequence representing a product of the first value and the third value.

12. The method according to claim 11, wherein
the fourth bit sequence represents a product of the first value and a value represented by the first and second bits, and
the seventh bit sequence represents a product of the first value and a value represented by the third and fourth bits.

13. The method according to claim 11, wherein
each of the fourth bit sequence and the seventh bit sequence includes one of the first bit sequence and the second bit sequence, or consists of bit values 0.

14. The method according to claim 13, wherein when a bit value of one of the first bit and the second bit is 1, and a bit value of other one of the first bit and the second bit is 0, the fourth bit sequence includes the first bit sequence, and
when bit values of both of the first bit and the second bit are 1, the fourth bit sequence includes the second bit sequence.

15. The method according to claim 12, further comprising:
generating a ninth bit sequence representing a product of the first value and a value represented by fifth and sixth bits of adjacent digits of the third bit sequence based on the first bit sequence, the second bit sequence, and the fifth and sixth bits, wherein
the generating the fifth bit sequence comprises summing the fourth bit sequence and the ninth bit sequence.

16. The method according to claim 11, further comprising:
outputting, based on a ninth bit sequence representing a fourth value, a tenth bit sequence representing a threefold value of the fourth value;
generating a twelfth bit sequence based on the ninth bit sequence, the tenth bit sequence, and fifth and sixth bits of adjacent digits of an eleventh bit sequence representing a fifth value;
generating, based on the twelfth bit sequence, thirteenth bit sequence representing a product of the fourth value and the fifth value;
generating a fifteenth bit sequence based on the. ninth bit sequence, the tenth bit sequence, and seventh and eighth bits of adjacent digits of a fourteenth bit sequence representing a sixth value;
generating, based on the fifteenth bit sequence, sixteenth bit sequence representing a product of the fourth value and the sixth value;
generating, based on the fifth bit sequence and the thirteenth bit sequence, a seventeenth bit sequence representing a sum of the product of the first value and the second value and the product of the fourth value and the fifth value; and
generating, based on the eighth bit sequence and the sixteenth bit sequence, an eighteenth bit sequence representing a sum of the product of the first value and the third value and the product of the fourth value and the sixth value.

17. The method according to claim 11, further comprising:
generating a ninth bit sequence based on the fifth bit sequence;
generating a tenth bit sequence based on the eighth bit sequence;
generating a twelfth bit sequence representing a product of a value represented by the ninth bit sequence and a value represented by an eleventh bit sequence;
generating a fourteenth bit sequence representing a product of a value represented by the tenth bit sequence and a value represented by a thirteenth bit sequence; and
generating a fifteenth bit sequence based on the twelfth bit sequence and the fourteenth bit sequence.

18. The method according to claim 11, wherein
after the second bit sequence is generated, the fifth bit sequence and the eighth bit sequence are generated without the second bit sequence being generated again.

19. The method according to claim 11, wherein
the third bit sequence and the sixth bit sequence are each learned based on training data.
